(19) United States
(12) Patent Application Publication
(10) Pub. No.: US 2024/0043025 A1
(43) Pub. Date: Feb. 8, 2024

(54) DIGITAL FRAMEWORK FOR AUTONOMOUS OR PARTIALLY AUTONOMOUS VEHICLE AND/OR ELECTRIC VEHICLES RISK EXPOSURE MONITORING, MEASURING AND EXPOSURE COVER PRICING, AND METHOD THEREOF

(71) Applicant: Swiss Reinsurance Company Ltd., Zürich (CH)

(72) Inventors: Luigi DI LILLO, Zürich (CH); Margherita ATZEI, Zürich (CH)

(73) Assignee: Swiss Reinsurance Company Ltd., Zürich (CH)

(21) Appl. No.: 18/481,664

(22) Filed: Oct. 5, 2023

Related U.S. Application Data
(63) Continuation of application No. PCT/EP2023/053226, filed on Feb. 9, 2023.

(30) Foreign Application Priority Data
Feb. 9, 2022 (CH) 000118/2022

(51) Int. Cl. B60W 50/06; B60W 60/00; G07C 5/02; G06F 30/20

(52) U.S. Cl. CPC B60W 50/06; B60W 60/0015; G07C 5/02; G06F 30/20; B60W 2050/0006

(57) ABSTRACT

Proposed is an electronic risk measuring and scoring system and method for an autonomous vehicle, comprising: an vehicle component valuation unit to valuate the autonomous vehicle; an automated ranking unit for determining ranking associated with forward-looking accident frequencies and severities for the autonomous vehicle based on the valuation thereof, and at least on one of operational risk data, contextual risk data, technical performance of the autonomous vehicle, legal risk data and cyber risk data therefor; a benchmarking unit for benchmarking autonomous vehicle risks associated with the autonomous vehicle based on testing and/or simulating an autonomous vehicle component modelling structure for the autonomous vehicle; a risk class unit for generating a risk space with one or more risk classes for the autonomous vehicle based on the benchmarking; and a scoring unit for generating scores or indices, to calibrate and rate and/or price risk-transfers, and/or as input for risk-transfer modeling.

### CROSS-REFERENCE TO RELATED APPLICATIONS

This application is a continuation of and claims benefit under 35 U.S.C. § 120 to International Application No. PCT/EP2023/053226 filed on Feb. 9, 2023, which is based upon and claims the benefit of priority from Swiss Application No. 000118/2022, filed Feb. 9, 2022, the entire contents of each of which are incorporated herein by reference.

### FIELD OF THE INVENTION

The present invention relates to autonomous vehicle driving, in particular to automated system for automated data capturing, operational data generation, risk assessment, and risk prediction in the field of autonomous vehicle driving or Advanced Driver Assistance Systems (ADAS) systems, which technically support the driver in the driving process. In particular, the present invention relates to systems and methods for risk transferring for autonomous vehicles driving systems and/or vehicles with ADAS system supported driving facilities, using information available from technological-based and scientific-based methodologies. More particularly, the present invention relates to electronic risk measuring and scoring system and method for autonomous vehicles providing risk assessment framework for a self-sufficient, automated risk protection for a variable number of risk-exposed motor vehicles.

Generally, the present invention relates to systems and methods for measuring and/or determining quantitative risk and/or risk exposure measuring values, automated pricing of covers for physical damages and/or impacts of occurring accident events (i.e. risk-transfer covers and/or premium level values also referred to as loss cover of accident risks), and automated provision of vehicle risk-transfer policies parameter value settings, specifically for vehicle operation which is partially or fully automated, as risk covers for Autonomous Vehicle (AV) operation. More particularly, it relates to digital systems based on intelligent or smart technology intended to facilitate interaction between physical and the cyber worlds, in particular digital twin technologies in order to achieve smart manufacturing, monitoring, steering, or predicting present or future states of a physical object, in particular autonomous vehicles. For some embodiment variants, an additional technical object relates to cope with the challenges to automatically capture sensitive data for connecting the physical and cyber world to work intelligently, which defines the digital twin (DT) technology or more generally to connect physical and cyber world to digital work intelligently. Finally, the present invention not only relates to operational risk measurement and assessment for autonomous or partially autonomous vehicle control, but also to operational risk measurement and assessment for autonomous or partially autonomous vehicle control to causing changes in the controlling of an autonomous vehicle based on an operational risk determined for the autonomous vehicle.

### BACKGROUND OF THE INVENTION

With the rapid growth of electric vehicles (EVs) in the past decade as well as the ongoing fast increase of used autonomous or partially autonomous vehicle steering together with the deployment of more and more ADAS (Advanced Driver-Assistance System) features and systems), many new traffic safety challenges are also emerging. In particular, since reliable and sufficient granular historical crash measuring data are missing for EV and/or ADAS crashes. The recent years, the proportion of EV crashes in total traffic crashes had risen from zero to 3.11% in Europe and the operation of almost all modern vehicles use or rely on more or less on ADAS features, where almost no data are available regarding exact impacts of the various single ADAS features on the probability of a vehicle to be involved in an accident event. In terms of severity and based on the rare statistical measuring data, EV and ADAS crashes show essentially very little to significant differences from Internal Combustion Engine Vehicle (ICEV) crashes, depending on the measuring data used. Compared to ICEV crashes the very few data available seem to indicate that the occurrence of EV and ADAS crashes feature on weekday peak hours, urban areas, roadway junctions, low-speed roadways, and good visibility scenarios, which, however, may be attributed merely to the fact that EVs and/or more modern cars with more sophisticated ADAS features are often more frequent to be found in urban local commuting travels. Regarding EVs, EVs are confirmed to be much more likely to collide with cyclists and pedestrians, probably due to their low-noise engines. However, the technical structure and weight distribution in EVs is typically completely different to ICEVs, so their physical behavior on the road in case of an accident event typically differs significantly. Further, there are no granular measuring data available to measurably quantify the impact of a specific ADAS feature on the occurrence frequency and thus the future occurrence probability measure of ADAS crashes.

Risk-cover, e.g., by appropriately adjusted risk-transfers, for ICEV vehicles or automobiles relies fundamentally on the measured and/or forecasted accident occurrence frequency and is known in the prior art providing cover against physical damage and/or bodily injury resulting from impacting traffic accidents and against liability that could arise therefrom. The amount of physical damage to a vehicle can e.g. be measurable in monetary equivalent values, since the physical damage can relate to various different vehicle components in type of component, technical function, and size etc., which may otherwise be difficult to measure with an interrelating measure. Typically, a user purchases a vehicle risk-transfer policy (each policy consisting of a specific risk-transfer parameter value setting) for a policy rate having a specified term with specified parameter value settings for the risk-transfer conditions (cover height, vehicle specifications etc.). In exchange for premium transfer (payments) from the insured user, the risk-transfer system covers possible occurring damages or other physical impacts to the user and/or the covered vehicle which are caused by covered perils, acts, or events as specified by the parameter settings of the risk-transfer policy. The payments from the user are generally referred to as “premiums,” and typically are transferred on behalf of the user or by the user to the risk-transfer system, over time at periodic intervals. A risk-transfer policy may remain “in-force” while premium transfers are made during the term or length of coverage of the policy as indicated in the policy. A risk-transfer policy may “lapse” (or have a status or state of “lapsed”), for example, when premiums are not being or not any more transferred or if the user or the risk-transfer system (or the insurer as risk-transfer provider) cancels the policy.

Premiums may be typically determined based upon a selected level of exposure coverage, location of vehicle operation, vehicle model, and/or characteristics or demographics of the vehicle operator. The characteristics of a vehicle operator that affect premiums may include age, years of operating, vehicles of the same class, prior incidents involving vehicle operation, and losses reported by the vehicle operator to the risk-transfer system or a previous risk-transfer provider/system. Past and current premium determination methods do not, however, account for use of autonomous vehicle operating features, in particular they are not able to measure quantitative and/or dynamically the actual risk-exposure of a partially and/or fully automated motor vehicle. The present invention allows, inter alia, to overcome these technical deficiencies and/or other technical drawbacks associated with conventional techniques.

Furthermore, modern vehicles are increasingly being automated to aid in the transport of passengers from one location to another without any, or minimal, human intervention. Autonomous car driving (also so-called driverless car, self-driving car, robotic car) is associated with vehicles that are capable of sensing its environment and navigating without human input. Autonomous vehicles are capable of detecting surroundings using radar, LIDAR (measuring device to measure distances by means of laser light), GPS (Global Positioning System), odometry (measuring device for measuring changings in position over time by means of using motion sensor data), and computer vision. In autonomous cars, advanced control systems interpret sensory information to identify appropriate navigation paths, as well as obstacles and relevant signage. Autonomous cars have control systems that are capable of analyzing sensory data to distinguish between different cars on the road, which is very useful in planning a path to the desired destination.

Most of the prior-art risk assessment systems do not assess the effectiveness of automated vehicles (AVs). That is, the impacts of the autonomous vehicles are not yet reflected in most motor risk-transfer assessment systems and consecutive pricings. In other words, though car makers invest a lot in safety technology, the impact of the autonomous vehicles is not properly considered by the prior-art risk-transfer technology. This is due to the applied backwards modelling (only) risk measuring structures, which have been mainly designed around demographic variables (as described above) as well as basic vehicle characteristics (e.g., vehicle type, engine displacement, engine power).

The problem with assessing autonomous vehicles is that not all autonomous vehicles are the same. This international standard for autonomous vehicles was defined in 2014 by the Society for Automotive Engineers International (SAE). It's based on six levels of classification from zero, for no automation, through to Level 5 for full automation. Factually, it is evident that the autonomous vehicles have a proven positive impact on accident frequency (i.e., reduction of accident frequency), making both cars and roads safer. However, the automation of vehicles was and is still not properly considered in the risk evaluation of most insurers (i.e., not in a systematic, consistent way). There are two main reasons for the same. Normally, it is difficult to know what level of automation is provided in a given autonomous vehicle, since this requires access to detailed car/build data or on-board systems. Further, it is difficult to propagate the impact of automation in a given autonomous vehicle in terms of claims frequency/severity (i.e., risk premium), since this requires deep and frequent interactions e.g., with the engineering/technical teams of automotive partners. This involves getting access to technical build data and understanding how the technology works in order to design the right assessment methodology and capture the autonomous vehicle's effectiveness in a risk-measuring and risk-transfer context.

The rapid emergence of autonomous vehicles presents the automobile insurance industry with major challenges but also with a significant near-term opportunity. The shift to autonomous vehicles will cause dramatic changes in how insurance premiums are generated. With most autonomous vehicles likely to be owned by original equipment manufacturers (OEMs), OTT players, and other service providers such as ride-sharing companies, the number of individual policies will decline, along with revenues from premiums generated by these policies. And, since autonomous vehicles will be considerably safer than vehicles driven by humans, there will be fewer road accidents, leading to reduced pricing for insurance policies. Estimates are that claim frequency could drop significantly when compared to claims for vehicles driven by humans. While insurers of autonomous vehicles will make fewer payouts for claims, this will not compensate them for lost policy revenues.

Autonomous car driving with integrated telematics may offer new technological fields, in particular in monitoring and steering by means of centralized expert systems, as e.g., in the risk-transfer technology far more accurate and profitable pricing models provided by such automated expert systems. This would create a huge advantage, in particular for real-time and/or usage-based and/or dynamically operated systems. For example, some states, for example, recently issued dynamic pay-as-you-drive (PAYD) regulations, which on the other side, allows insurers to offer drivers insurance rates based on actual versus estimated miles driven.

Apart from autonomous car driving, automotive engineering is, in fact, more common for aerospace engineering and marine engineering, than for vehicle engineering. Though, automotive engineering comprises similar technical means in the different fields, it does not completely overlap. Automotive car engineering comprises elements of mechanical, electrical, electronic, software and safety engineering as applied to the design, manufacture and operation of motorcycles, automobiles and trucks and their respective engineering subsystems. One important aspect of automotive engineering is related to safety engineering: Safety engineering is the assessment of various crash scenarios and their impact on the vehicle occupants. These are tested against very stringent regulatory or governmental regulations. Some of these requirements include: seat belt and air bag functionality testing, front and side impact testing, and tests of rollover resistance. Assessments are done with various methods and tools, including computer crash simulation (typically finite element analysis), crash test dummies, and partial system sled and full vehicle crashes. Other important aspects of automotive engineering relate, for example, to (i) fuel economy/emissions optimization systems, (ii) vehicle dynamics optimization (vehicle dynamics is the vehicle's response of attributes as e.g. ride, handling, steering, braking, comfort and traction), (iii) NVH (noise, vibration, and harshness) engineering (i.e. the customer's feedback systems both tactile (felt) and audible (heard)) from the vehicle, (iv) vehicle electronics engineering, in particular automotive electronics engineering, which systems are responsible for operational controls such as the throttle, brake and steering controls; as well as comfort and convenience systems such as the HVAC (heating, ventilating, and air conditioning) systems, infotainment systems, and lighting systems. Automotive systems with modern safety and fuel economy requirements are not possible without electronic controls, (v) performance control system (e.g. how quickly a car can accelerate (e.g. standing start 100 m elapsed time, 0-100 km/h, etc.), top speed, how short and quickly a car can come to a complete stop from a set speed (e.g. 50-0 km/h), how much g-force a car can generate without losing grip, recorded lap times, cornering speed, brake fade, or the amount of control in inclement weather (snow, ice, rain)), (vi) shift quality systems (driveline, suspension, engine and power-train mounts, etc.), (vii) durability and corrosion engineering including controls under mileage accumulation, severe driving conditions, and corrosive salt baths etc., (viii) package/ergonomics engineering, as occupant's access to the steering wheel, pedals, and other driver/passenger controls, (ix) climate control, as windshield defrosting or heating and cooling capacity, (x) Drivability engineering as e.g. the vehicle's response to general driving conditions, e.g. cold starts and stalls, RPM (revolutions per minute) dips, idle response, launch hesitations and stumbles, and performance levels etc., (xi) quality control engineering, as e.g. systems to minimize risks related to product failures and liability claims of automotive electric and electronic systems etc. Finally, an important aspect of autonomous vehicle driving typically relates to modern telematics means and systems. In electronic, telecommunication and insurance industry, the technology is adopting similar and consistent technical strategies to improve the effectiveness of interactions with mobile systems and devices, but also with the customer or user of those systems, which today increasingly is a pure technology component. Further, social networking, telematics, service-oriented architectures (SOA) and usage-based services (UBS) are all in interacting and pushing this development. Social platforms, as e.g., Facebook, Twitter, and YouTube, offer the ability to improve customer interactions and communicate product information. However, the field of telematics is larger still, as it introduces entirely new possibilities that align the technical input requirements and problem specifications of dynamic risk-transfer, technology, and mobility. SOA and telematics are becoming key to managing the complexity of integrating known technologies and new applications.

As mentioned above, autonomous vehicle electronics engineering, which systems are responsible for operational controls of the vehicle such as the throttle, brake controls, steering controls, and lighting systems, is one of the key technologies in automotive car driven. Automotive systems with modern steering, safety and fuel economy requirements are not possible without appropriate electronic controls. Typically, the use of telematics means constitutes a central part of the autonomous vehicle electronics engineering. Telematics, in the context of autonomous car driving, comprises telecommunications, vehicular technologies, road transportation, road safety, electrical engineering (sensors, instrumentation, wireless communications, etc.), and information technology (multimedia, Internet, etc.). Thus, also the technical field of telematics are affected by a wide range of technologies as the technology of sending, receiving and storing information via telecommunication devices in conjunction with affecting control of remote objects, the integrated use of telecommunications and informatics for application in vehicles and e.g., with control of vehicles on the move, GNSS (Global Navigation Satellite System) technology integrated with computers and mobile communications technology in automotive navigation systems. The use of such technology together with road vehicles, is also called vehicle telematics. In particular, telematics triggers the integration of mobile communications, vehicle monitoring systems and location technology by allowing a new way of capturing and monitoring real-time data. Usage-based risk-transfer systems, as e.g., provided by the so-called Snapshot technology of the firm Progressive, links risk-transfer compensation or premiums to monitored driving behavior and usage information gathered by an in-car telematics device. In relation to automotive car systems, telematics typically further comprises installing or embedding telecommunications devices mostly in mobile units, as e.g., cars or other vehicles, to transmit real-time driving data, which for example can be used by third parties' system, as automated risk-monitoring, and risk-transfer systems, providing the needed input e.g., to measure the quality and risks, to which the vehicle is exposed to. Various telematics instruments are available in the market, as e.g., vehicle tracking and global positioning satellite system (GPS) technologies or telecommunications devices that allow being connected from almost anywhere. In particular, dynamically monitored, and adapted risk-transfer could be imaginable by interconnecting telematics of the autonomous car driving system with other real-time measuring systems. After getting involved in a car accident, emergency and road services could be automatically activated, vehicle damage assessed, and the nearest repair shop contacted. In summary, the traditional operability of risk-transfer systems and insurance coverage could be transformed to real-time navigation and monitoring, including the automated activation of concierge service, safe driving tips, video-on-demand for the kids in the backseat, in-car or online feedback, and real-time vehicle diagnostics.

In addition to real-time surveillance, it is to be mentioned, that an insurance agent may want to exchange information with a customer associated with an insurer for a number of different reasons. However, the information exchange between the customer and the insurer and/or the insurer and the reinsurer mostly is still cumbersome and time-consuming, and thus, risk-transfers provided by such structures typically remain static within a fixed time period agreed upon. For example, an existing or potential consumer may access an insurance agent's web page to determine a yearly or monthly cost of an insurance policy (e.g., hoping to save money or increase a level of protection by selecting a new insurance company). The consumer may provide basic information to the insurance agent (e.g., name, type of business, date of birth, occupation, etc.), and the insurance agent may use this information to request a premium quote from the insurer. In some cases, the insurer will simply respond to the insurance agent with a premium quote. In other cases, however, an underwriter associated with an insurer will ask the insurance agent to provide additional information so that an appropriate premium quote can be generated. For example, an underwriter might ask the insurance agent to indicate how often, where and to which time a motor vehicle is mainly used or other data as age of the motor vehicle and indented use (transportation etc.). Only after such additional information is determined, an appropriate risk analysis can be performed by the insurer to process adapted underwriting decisions, and/or premium pricing.

From the above discussion, it may be concluded that a lot in safety technology, in particularly for autonomous vehicles, is not sufficiently considered by the prior-art systems in the risk-transfer technology and measuring systems. Accordingly, it is one object of the present disclosure to provide methods and systems for inventive risk score that bridges the gap and provides the risk-transfer technology with the missing piece of information available from scientific-based and technological-based methodology. That is, there is an immediate need for reliable, automated risk assessment and risk-transfer systems in the field of automobile risk-transfer industry, considering both liability and comprehensive risk-transfer, and particularly for autonomous vehicles. The field of automobile risk-transfer is characterized by highly competitive pressure as well as high combined ratios and, hence, by low profitability. Thus, there is a high demand to provide automatable systems, even in the complex sector of physically measuring of typically (i.e., by prior-art systems) not measurable risks and system-based, automated risk-transfer.

In summary, the threat posed to traditional automobile insurers by the rapid evolution of autonomous vehicles is real, but so is the multi-billion opportunity represented by new forms of cyber, product liability, and infrastructure insurance. Early mover advantage will go to insurers getting a jump on actuarial modeling, developing new product offerings, creating new distribution channels, and forming partnerships with new premium payers—all critical elements of success.

Also, from the above, it may be understood that traditional risk assessment of the prior-art systems mainly employs statistically based structures by appropriate class factors, e.g., age, gender, marital status, number of driving years etc., such assessments necessarily lead to preferred class ratings with the corresponding deficiencies in providing the correct risk for a specific driver. Statistical based structures are always linked to mean values and means assumptions. The deficiencies of the prior-art assumptions lay in the fact, that they contract all driver of a certain class to the means assumption of the class, while, in fact, this is only absolutely true for a very minor part of a certain class, while the predominant remaining members of the class typically are distributed in Poisson distribution around the means value, i.e., for this predominant remaining part, the assumption is more or less wrong leading to a probably unfair risk rating of the driver. Therefore, the prior-art systems risk predictions and ratings are afflicted with major deficiencies in relation to the actual occurring driving risk. Thus, it is a high demand on reliable, automated risk assessment and risk-transfer systems in the field of automobile risk-transfer industry, considering both liability and comprehensive risk-transfer.

The prior art document US 2018/0075538 A1 shows a systems for determining the effectiveness of different autonomous or semi-autonomous operation features of a vehicle are provided. Information regarding autonomous operation features of the vehicle is used to determine an effectiveness metric indicative of the ability of each autonomous operation feature to avoid or mitigate accidents or other losses. The information includes operating data from the vehicle or other vehicles having similar autonomous operation features, test data, or loss data from other vehicles. The determined effectiveness metric may then be used to determine part or all of an insurance policy, which may be reviewed by an insured and updated based upon the effectiveness metric. Further, the prior art document US 2017/0372431 A1 discloses an expert-system based circuit. A first risk-transfer system is configured to provide a first risk-transfer based on first risk-transfer parameters from a plurality of motor vehicles to the first risk-transfer system, and receive and store first payment parameters associated with risk exposures of the plurality of motor vehicles. A second risk-transfer system is configured to provide a second risk-transfer based on second risk-transfer parameters from the first risk-transfer system to the second risk-transfer system, and receive and store second payment parameters associated with risk exposures transferred to the first risk-transfer systems. The expert-system based circuit captures environmental parameters and operating parameters from the plurality of motor vehicles, automatically adjust the first risk transfer parameters and correlated first payment transfer parameters, and automatically adjust the second risk transfer parameters and correlated second payment transfer parameters based on the captured environmental parameters and operating parameters. Finally, the prior art document US 2015/0170287 A1 discloses a system providing automated insurance claims handling, underwriting, and risk assessment applications utilizing autonomous vehicle data. The autonomous vehicle data are utilized to (i) determine a risk assessment for a vehicle, fleet of vehicles, individual, household, and/or policy, (ii) determine an underwriting parameter, (iii) quote an insurance policy, (iv) sell an insurance policy, and/or (v) determine a type, blend, and/or mix of insurance types. Risk assessment and/or insurance underwriting, pricing, quotation, sales, and/or claims processes is conducted substantially similarly to approaches known in the art, where autonomous vehicle data are then be utilized to weight, adjust, scale, or otherwise modify the resulting risk assessment, underwriting, sales, and/or other insurance product-related determination.

### SUMMARY OF THE INVENTION

The technical revolution in autonomous vehicles presents a technical challenge for risk-transfer systems in three key areas: 1. Damage impacts caused by deficiencies in cyber security 2. Component related risk and associated liabilities for sensors and/or data processing structures 3. Hedging against infrastructure problems. In case of “cyber security,” the opportunities can also include protecting against vehicle theft, unauthorized vehicle entry, and the use of “ransomware” to hold vehicles hostage until payments are made to unlock software controls. Risk-transfer system may also be designed to protect against criminal or terrorist hijacking of vehicle controls through hacking. And, with many cars serving as connected devices, risk-transfer systems will try to provide protection against identity theft, privacy invasion, and the theft or misuse of personal information. In case of “product liability,” risk-transfer system may try to cover manufacturers' liability for communication or Internet connection failure as well as for the potential failure of software—including software bugs, memory overflow, and algorithm defects—and hardware failures such as sensory circuit failure, camera vision loss, and radar and lidar (light detection and ranging) failures. In case of “infrastructure problems,” autonomous vehicle manufacturers and/or service providers will need to shoulder responsibility for the infrastructure put in place to control vehicle movements and traffic flow. This will include cloud server systems (which can malfunction, become overloaded or suffer interruptions from outside factors); failure of external sensors and signals; and communication problems originating at the system level.

It is an object of the invention to provide systems and technical frameworks for such systems and methods for digital, automated autonomous vehicle risk assessment and measuring. It is a further object of the present invention to provide an electronic risk measuring and scoring system for autonomous vehicles (AVs). The electronic risk measuring and scoring system is characterized in that the electronic risk measuring and scoring system comprises an autonomous vehicle component valuation unit to evaluate the autonomous vehicle. The electronic risk measuring and scoring system is further characterized in that the electronic risk measuring and scoring system comprises an automated ranking unit for determining ranking associated with forward-looking accident frequencies and severities for the autonomous vehicle based on the valuation thereof, and at least on one of operational risk data, contextual risk data, technical performance of the autonomous vehicle, legal risk data and cyber risk data therefor. The electronic risk measuring and scoring system is further characterized in that the electronic risk measuring and scoring system comprises a benchmarking unit for benchmarking autonomous vehicle component risks and/or autonomous vehicle risks associated with the autonomous vehicle based on testing and/or simulating an autonomous vehicle component modelling structure for the autonomous vehicle using technology data associated with the autonomous vehicle. The electronic risk measuring and scoring system is further characterized in that the electronic risk measuring and scoring system comprises a risk class unit for generating a risk space with one or more risk classes for the autonomous vehicle based on the benchmarking. The electronic risk measuring and scoring system is further characterized in that the electronic risk measuring and scoring system comprises a scoring unit for generating scores or indices, calibrating and rate and/or price risk-transfers, and/or as input for risk-transfer modeling, based on the one or more risk classes for the autonomous vehicle and the ranking associated with the forward-looking accident frequencies and severities for the autonomous vehicle.

As mentioned, it is an object of the present invention to provide an electronic risk measuring and scoring method for an autonomous vehicle. The electronic risk measuring and scoring method is characterized in that valuating, parametrizing, and assessing, by an autonomous vehicle component valuation unit, the autonomous vehicle. The electronic risk measuring and scoring method further comprises determining, by an automated ranking unit, ranking associated with forward-looking accident frequencies and severities for the autonomous vehicle based on the valuation thereof, and at least on one of operational risk data, contextual risk data, technical performance of the autonomous vehicle, legal risk data and cyber risk data thereof. The electronic risk measuring and scoring method is further characterized in that benchmarking, by a benchmarking unit, autonomous vehicle component risks associated with the autonomous vehicle based on testing and/or simulating an autonomous vehicle component modelling structure for the autonomous vehicle using technical parameter values associated with the autonomous vehicle. The electronic risk measuring and scoring method further comprises generating, by a risk class unit, a risk space with one or more risk classes for the autonomous vehicle based on the benchmarking. The electronic risk measuring and scoring method comprises generating, by a scoring system, scores, or indices, to calibrate and rate and/or price risk-transfers, and/or as input for risk-transfer modeling, based on the one or more risk classes for the autonomous vehicle and the ranking associated with the forward-looking accident frequencies and severities for the autonomous vehicle. Finally, it is to be noted that it is a further technical object to provide based on the inventive system with the AV risk assessment relying on a measured physical accident probability or accident risk values an underwriter or user with a reliable measure on the underlying physical good-bad accident risk. Such a measure also allows for an automated pricing generation for a risk cover to be automatically provided by the system 1. Such an automated pricing engine does not have to be limited to motor risks and liability but also personal risks as e.g., PL (Personal Liability). It is explicitly an advantage of the present inventive system to provide an automated engine and measuring system, which can easily be extended to Asia-Pacific (APAC) regions and/or cover other artificial intelligence (AI)-related risk measuring, beyond those related to automotive.

According to the present invention, these objects are achieved particularly through the features of the independent claims. In addition, further advantageous embodiments follow from the dependent claims and the description.

According to the present invention, the abovementioned objects are particularly achieved by the electronic risk measuring and scoring system and method for an autonomous vehicle of the present invention providing a technical framework for signaling of automated risk-transfer. The inventive technical framework comprises the steps of (a) autonomous vehicle component assessment and valuation, (b) risk assessment by ranked risks at least based on operational risks and/or contextual risks and/or technical performance and/or legal risks and/or cyber risks, (c) benchmarking autonomous vehicle components and autonomous vehicle component risks by testing and simulation, (d) providing scores used for tariffication and risk-transfer modelling, and (e) using risk ranking to generate a global risk space with appropriate risk classes, and (f) streamlining and/or optimizing underwriting decisions. Herein, the ranking is used two-fold. Firstly, the ranking is used to provide a global risk space, create appropriate risk classes, and streamline underwriting decisions. Secondly, the ranking is used for benchmarking the autonomous vehicle components and autonomous vehicle component risks or autonomous vehicle risks by means of appropriate testing and simulations and providing score measures and/or indices used for tariffications and/or as input parameters for insurance/risk-transfer modelling. Thus, the present electronic risk measuring and scoring system and method providing the autonomous vehicle risk assessment framework addresses the classic problem of risk-assessment and optimized risk-cover for non-life risks and the related difficulties to control/monitor/predict appropriate risk covers and risk-transfer pricing.

In summary, the advantages of the present invention are, inter alia, that the present system and method is able to measure and differentiate fully autonomous driving modes and the various level of manual and partially manual driving modes (ADAS). The present system and method measure which mode is selected and appropriately adjust the risk-transfer parameters and premiums (for example higher risk, if the car is driven manually by a person; however, depends on the measured contextual data). It is to be assumed that the premiums for traditional vehicles in a world of increased numbers of semi- or fully autonomous vehicles will go up. This can be captured by the dynamic generation of the appropriate risk-transfer and payment-transfer parameters by means of the present expert-system based invention, which is not possible by the known prior art systems. The present system and method dynamically take into account the used and/or activated ADAS/AV features, as well as their performance accuracy and operational quality to generate the variable and time-dependent risk-transfer parameters and the premium (e.g., safety features of the car type, model) and the ADAS systems (e.g., highway pilot, Park Assistance, Forward Collision Warning, Driver Monitoring, Lane Departure warning). The present system and method also consider the ADAS features in their contextual relation, as e.g., under different weather conditions. However, for partially autonomous driving cars (ADAS) different user interaction based on different drivers are automatically considered by capturing and transmitting user-based data. Thus, the present system and method can automatically adapt its operational parameters and be used, for example, in a rental scheme or borrowed scheme. Further, the present system and method are automatically able to differentiate and adapt its operational parameters (e.g., risk-transfer parameters) in connection with MTPL (Motor Third Party Liability) and/or MOD (Motor own Damage) covers with ADAS/AV risk parameters, and/or product liability to manufacturer (technology (for software/hardware) and car manufacturer), and/or maintenance failure by owner, and/or driverless taxi risk-transfer schemes, and/or car rental risk-transfer schemes, and/or transportation network companies risk-transfer schemes (like Uber (UberX, UberBlack, UberPop, or UberTaxi)), and/or private car sharing risk-transfer schemes. The defined risk events associated with transferred risk exposure of the autonomous vehicles can, for example, at least comprise transferred risk exposure related to liability risk-transfers for damages and/or losses and/or delay in delivery, wherein the occurred loss is automatically covered.

In one or more embodiments, the autonomous vehicle component valuation unit of the electronic risk measuring and scoring system and method performs an assessment and/or valuation of the autonomous vehicle based on at least one of age of the autonomous vehicle, health of engine of the autonomous vehicle, distance traveled by the autonomous vehicle, service history of the autonomous vehicle, and accident history of the autonomous vehicle. In a risk-transfer context, the present autonomous vehicle component valuation and/or assessment can be used to assess the market value of the autonomous vehicle as an abstract measure for the possibly occurring physical loss to ensure that adequate cover by the risk-transfer system is assigned. Autonomous vehicle components can e.g. include the vehicle components as such and the autonomous driving components that enable autonomous driving comprising (i) sensors, (ii) semiconductors, and (iii) operating and steering software, data processing means and signaling devices. Sensors, including cameras, Light Detection and Ranging (LiDAR), and radar are used together to help vehicles see road conditions at various distances, and in different weather and lighting conditions. The autonomous-driving components can e.g. be classified into electronic scene recognition, path planning, and vehicle control means. Each class can comprise a set of sophisticated algorithms. For instance, scene recognition requires localization, object-detection, and object-tracking data processing structures. Path planning often falls into mission and motion planning, whereas vehicle control corresponds to path following. Where no useful or relevant data (e.g. of recent market transactions) are assessable which can be used to value a vehicle component, the inventive system can e.g. use DRC (Depreciated Replacement Cost) methods to determine the accurate monetary equivalent value/replacement value a vehicle component.

In an example, the electronic risk measuring and scoring system uses autonomous vehicle's registration data and processes (i) motor vehicle pricing data to identify book prices corresponding to types of motor vehicles (e.g., as identified in the registration data) and (ii) motor vehicle auction data to identify auction prices corresponding to the types of motor vehicles. Based on the book prices and auction prices, the electronic risk measuring and scoring system generates a report with the valuation of the autonomous vehicle. In some embodiments, the auction price for the autonomous vehicle may be the average auction price of all the motor vehicles sold at auction corresponding to that type (e.g., excluding “salvage” or “as-is” auctions). In some embodiments, the book price for the autonomous vehicle may be determined based on the average mileage of all the motor vehicles sold at auction corresponding to that type, a base book price for that type of motor vehicle, and at least one mileage adjustment factor. If the average mileage for the autonomous vehicle is above or below an expected mileage, the electronic risk measuring and scoring system will decrease or increase the valuation for the autonomous vehicle by an amount indicated in the at least one mileage adjustment factor. In some embodiments, if the average mileage for that type of motor vehicle is within an expected mileage, or if the electronic risk measuring and scoring system does not consider mileage in determining the book price, the electronic risk measuring and scoring system may set the book price to be the base book price. As embodiment variant, the electronic risk measuring and scoring system can e.g., automatically capture scores risks according to a measured maintenance (e.g., maintenance failure by owner) and surveillance factor extracted from the automotive data associated with the autonomous or partially autonomous vehicle and/or the control systems or the use of active safety features.

In another example, in order to achieve the aforementioned valuation, consideration is given to residual value forecasting procedures including (1) collecting transaction data of the goods classified in a same category, (2) extracting the elapsed time and residual value (secondhand price) at the time of transaction from the respective transaction data, (3) approximating the function against the extracted data (elapsed time, residual value), and (4) forecasting the residual value in a prescribed future based on such approximate function. Upon designing a residual value insurance based on the forecasted residual value, a step of (5) designing the residual value insurance based on the forecasted residual value (calculation of insurance premium) is added to the procedures.

In one or more embodiments, the operational risk data comprise can e.g. be related to possibly occurring accidents, i.e. accident risks, due to operations of the autonomous vehicle. Most statistical analyses of accidents are based on either frequency or severity or both. The standard frequency rate represents the number of occurrences for measure hours of exposure. The standard severity rate is the measured impact as a result of the occurrences for the measured number of hours of exposure. Thus, the frequency rate indicates how many accidents are occurring in relation to number of hours driven in case of the autonomous vehicles and the severity rate indicates how severe are those physical impact caused by the measured accidents. The objective is to reduce both the frequency with which accidents occur and the frequency with which they threaten. It may be appreciated that frequency and severity rate vary from one autonomous vehicle to another autonomous vehicle. These differences reflect not only the inherent differences in the autonomous vehicles from different manufacturers but also many other factors including the efficiency of such different autonomous vehicles and/or the typical use of specific type of autonomous vehicle.

In an example, the operational risk data may be determined for the autonomous or semi-autonomous vehicle technology and/or the autonomous or semi-autonomous driving package of computer instructions based upon an ability of the autonomous or semi-autonomous vehicle technology and/or computer instructions to avoid collisions without human interaction. The ability to avoid collisions without human interaction may further correspond to one or more of the following: (1) a type of the autonomous or semi-autonomous vehicle technology, (2) a version of computer instructions of the autonomous or semi-autonomous vehicle technology, (3) an update to computer instructions of the autonomous or semi-autonomous vehicle technology, (4) a version of artificial intelligence associated with the autonomous or semi-autonomous vehicle technology, and/or (5) an update to the artificial intelligence associated with the autonomous or semi-autonomous vehicle technology. Additionally, the received information regarding at least one of (1) the autonomous or semi-autonomous vehicle technology or (2) the accident-related factor may include at least one of a database or a model of accident risk assessment, which may be based upon information regarding at least one of (a) past vehicle accident information or (b) autonomous or semi-autonomous vehicle testing information. Moreover, the accident-related factor may be related to at least one of the following: a point of impact; a type of road; a time of day; a weather condition; a type of a trip; a length of a trip; a vehicle style; a vehicle-to-vehicle communication; and/or a vehicle-to-infrastructure communication.

In one or more embodiments, the contextual risk data comprises real-time driving behaviors of the autonomous vehicle. Traditional auto insurance actuarial models are based on static factors, such as driver's socio-demographic information, type of vehicle, driving record, and so on. The rapid growth of the autonomous vehicles provides the feasibility of collecting individualized, high-fidelity, and high-resolution driving data from the vehicles, which makes it possible for the insurance providers to look into a new personalized insurance with the goal of more accurately calibrating autonomous vehicle's behavior and differentiating autonomous vehicles according to their driving risks in the actuarial modeling process. The present invention proposes an approach that collects individualized driving behavior data from the autonomous vehicles, combined with geographical network information and dynamic traffic conditions, to identify driving risk factors and evaluate driving behaviors under various contexts. The multi-source data reveals real world activity patterns as to when, where and how different autonomous vehicles (say from different manufacturers and/or using different automation systems) perform, to measure the risks in those patterns. In addition, the crash history of different autonomous vehicles is also collected, so the relationship between the defined driving performance measurements and accident rate can be examined and verified. The multi-source data collection and processing is described in detail in this disclosure, with a list of context-based driving risk measurements defined at trajectory and link level, trip level, and individual level, respectively. In an example, a Poisson regression model may be calibrated to link driving behavior with crash history by using driving performance and traffic conditions as explanatory variables, the results suggest that driving performance captured from vehicle trajectories are important indicators of driving risks, and thus useful to calibrate and rate and/or price risk-transfers, and/or as input for risk-transfer modeling.

In an example, the benefit of one or more autonomous or semi-autonomous functionalities or capabilities may be determined, weighted, and/or otherwise characterized. For instance, the benefit of certain autonomous or semi-autonomous functionality may be substantially greater in city or congested traffic, as compared to open road or country driving traffic. Additionally or alternatively, certain autonomous or semi-autonomous functionality may only work effectively below a certain speed, i.e., during city driving or driving in congestion. Other autonomous or semi-autonomous functionality may operate more effectively on the highway and away from city traffic, such as cruise control. Further individual autonomous or semi-autonomous functionality may be impacted by weather, such as rain or snow, and/or time of day (day light versus night). As an example, fully automatic or semi-automatic lane detection warnings may be impacted by rain, snow, ice, and/or the amount of sunlight (all of which may impact the imaging or visibility of lane markings painted onto a road surface, and/or road markers or street signs).

Further, in an example, automobile insurance premiums, rates, discounts, rewards, refunds, points, etc. may be adjusted based upon the percentage of time or vehicle usage that the vehicle is the driver, i.e., the amount of time a specific driver uses each type of autonomous (or even semi-autonomous) vehicle functionality. In other words, insurance premiums, discounts, rewards, etc., may be adjusted based upon the percentage of vehicle usage during which the autonomous or semi-autonomous functionality is in use. For example, automobile insurance risk, premiums, discounts, etc. for an automobile having one or more autonomous or semi-autonomous functionalities may be adjusted and/or set based upon the percentage of vehicle usage that the one or more individual autonomous or semi-autonomous vehicle functionalities are in use, anticipated to be used or employed by the driver, and/or otherwise operating. Such usage information for a particular vehicle may be gathered over time and/or via remote wireless communication with the vehicle. One embodiment may involve a processor on the vehicle, such as within a vehicle control system or dashboard, monitoring in real-time whether vehicle autonomous or semi-autonomous functionality is currently operating. Other types of monitoring may be remotely performed, such as via wireless communication between the vehicle and a remote server, or wireless communication between a vehicle-mounted dedicated device (that is configured to gather autonomous or semi-autonomous functionality usage information) and a remote server.

The adjustments to automobile insurance rates or premiums based upon the autonomous or semi-autonomous vehicle-related functionality or technology may take into account the impact of such functionality or technology on the likelihood of a vehicle accident or collision occurring. For instance, a processor may analyze historical accident information and/or test data involving vehicles having autonomous or semi-autonomous functionality. Factors that may be analyzed and/or accounted for that are related to insurance risk, accident information, or test data may include (1) point of impact; (2) type of road; (3) time of day; (4) weather conditions; (5) road construction; (6) type/length of trip; (7) vehicle style; (8) level of pedestrian traffic; (9) level of vehicle congestion; (10) atypical situations (such as manual traffic signaling); (11) availability of internet connection for the vehicle; and/or other factors. These types of factors may also be weighted according to historical accident information, predicted accidents, vehicle trends, test data, and/or other considerations.

In one or more embodiments, the technical performance of autonomous vehicle comprises performance of the autonomous vehicle in terms of at least one of autonomous driving capability, automation level of the autonomous vehicle and navigation accuracy of the autonomous vehicle. As far as the understanding of the current scenario around normal and autonomous vehicles (AVs) is concerned, there can e.g. be in total six levels of automation identified that determine the independency and operational potential of any vehicle. These can range from zero to five as follows:
Level Zero: There is a total reliance on a human driver for driving and other operations at zero level automation of a vehicle.
Level One: The vehicle has an affixed ADAS or Advanced Driver Assistance System which enhances the driving experience by expediting either of the following processes: accelerating, steering, or braking, by providing assistance to the driver with respect to same.
Level Two: In this level of automation, the ADAS looks into all the three functions of accelerating, steering, and braking in certain circumstances. However, the ultimate control still vests with the human driver who looks into additional tasks that are involved in driving a vehicle.
Level Three: Level Three is the first stage of actual advancement in vehicular technology as ADS or advanced driving system comes into action. ADS can control almost all the tasks associated with driving till the time it requests the human driver to take control over the operation. In such a circumstance, a human driver is required to follow accordingly.
Level Four: At level four, in a majority of the situations, ADS can self-automate all the functions and driving tasks with next to negligible human intervention.
Level Five: This is the most advanced stage of automation in which the ADS can fully operate and control the vehicular mobility without no assistance from any human driver whatsoever. This level of automation can be enabled with the involvement of 5G technology as it will also make it possible for the vehicles to communicate not just with the other automobiles on the road but also traffic signals, signs, and roads.

Another important checkpoint that needs to be addressed while discussing driving is maintaining the speed of the vehicle. In autonomous vehicles, this is ensured by ACC or adaptive cruise control which helps in ensuring a proper distance between two vehicles and adjusts the speed automatically.

As may be understood, the autonomous operation features may take full control of the vehicle under certain conditions, viz. fully autonomous operation, or the autonomous operation features may assist the vehicle operator in operating the vehicle, viz. partially autonomous operation. Fully autonomous operation features may include systems within the vehicle that pilot the vehicle to a destination with or without a vehicle operator present (e.g., an operating system for a driverless car). Partially autonomous operation features may assist the vehicle operator in limited ways (e.g., automatic braking or collision avoidance systems). The autonomous operation features may affect the risk related to operating a vehicle, both individually and/or in combination. To account for these effects on risk, some embodiments evaluate the quality of each autonomous operation feature and/or combination of features. This may be accomplished by testing the features and combinations in controlled environments, as well as analyzing the effectiveness of the features in the ordinary course of vehicle operation. New autonomous operation features may be evaluated based upon controlled testing and/or estimating ordinary-course performance based upon data regarding other similar features for which ordinary-course performance is known.

Some autonomous operation features may be adapted for use under particular conditions, such as city driving or highway driving. Additionally, the vehicle operator may be able to configure settings relating to the features or may enable or disable the features at will. Therefore, some embodiments monitor use of the autonomous operation features, which may include the settings or levels of feature use during vehicle operation. Information obtained by monitoring feature usage may be used to determine risk levels associated with vehicle operation, either generally or in relation to a vehicle operator. In such situations, total risk may be determined by a weighted combination of the risk levels associated with operation while autonomous operation features are enabled (with relevant settings) and the risk levels associated with operation while autonomous operation features are disabled. For fully autonomous vehicles, settings or configurations relating to vehicle operation may be monitored and used in determining vehicle operating risk.

Information regarding the risks associated with vehicle operation with and without the autonomous operation features may then be used to determine risk categories or premiums for a vehicle insurance policy covering a vehicle with autonomous operation features. Risk category or price may be determined based upon factors relating to the evaluated effectiveness of the autonomous vehicle features. The risk or price determination may also include traditional factors, such as location, vehicle type, and level of vehicle use. For fully autonomous vehicles, factors relating to vehicle operators may be excluded entirely. For partially autonomous vehicles, factors relating to vehicle operators may be reduced in proportion to the evaluated effectiveness and monitored usage levels of the autonomous operation features. For vehicles with autonomous communication features that obtain information from external sources (e.g., other vehicles or infrastructure), the risk level and/or price determination may also include an assessment of the availability of external sources of information. Location and/or timing of vehicle use may thus be monitored and/or weighted to determine the risk associated with operation of the vehicle.

In one or more embodiments, the legal risk parameter values and data can e.g. comprise parameter indication or measures for jurisdiction, vehicle liability and driver liability. As discussed, a self-driven, autonomous, or driverless vehicle is one which is manufactured with the ability to operate itself and discharge essential functions without the need of any human involvement through the technologically advanced sensory facility to perceive its surroundings. For the same purpose, a fully automated driving system is used in such a vehicle so as to make it competent in responding to the external environment the way a human driver manages to do autonomous vehicle is marketed by manufacturers as a safe and comfortable alternative to traditional vehicles. Studies which suggest that autonomous vehicle will reduce vehicle accidents and road deaths tend to assume a technology that is advanced and integrated. The rise of automated vehicles is usually represented as labor-retentive and accident-reducing. However, the societal and therefore, the subsequent legal impact of these advanced robotic motors is certainly very extensive and cannot be disregarded. Since the revolution has begun majorly in the developed world, there exist laws governing the operation of these technology-driven autonomous vehicles in these countries. Significant issue that arises with respect to providing legal sanction to autonomous vehicles is the allocation of liability in case a self-driven vehicle hits a pedestrian or another automobile on the road.

Due to the adoption of the Vienna Convention on Road Traffic, 1968 by the majority of the global states, which required a human driver to be an all-time controller of their vehicle on road, automated driving tests were not being considered by the governments across the world for a very long time. This continued till an amendment to Article 8 of the Convention was made in the year 2014 where the countries took cognizance of the changing and evolving technology and provisioned for making it legally permissible to drive a vehicle as long as it can be “overridden” or “switched off” by a human driver. There is a paradigm shift in the global automobile industry, states across the world are pushing for laws and regulations to address the issues connected with this advanced technology such as security, accountability, and privacy of the users. Despite not being present in large numbers in their countries, governments of the United States of America, United Kingdom, Australia, Canada, New Zealand, China, and Germany have started deliberating on an evolved jurisprudence associated with this new scientific advancement that is seen as the future of global transportation.

The issue of a legal framework which transfers driving responsibility is relevant to all users and stakeholders in autonomous vehicle. While it is predominantly in the interests of drivers and other road users for this framework to be sufficiently addressed, developers, manufacturers and regulators may benefit from engaging with the problems identified, in order to proactively deal with these issues in the interests of supporting a safe system of autonomous vehicle on public roads. Products liability law provides the framework for seeking remedies when a defective product (or misrepresentations about a product) causes harm to persons or property. It is a complex and evolving mixture of tort law and contract law. Tort law addresses civil, as opposed to criminal, wrongs (i.e., “torts”) that cause injury or harm, and for which the victim can seek redress by filing a lawsuit seeking an award of damages. A common tort, both in products liability and more generally, is negligence. Contract law is implicated by the commercial nature of product marketing and sales, which can create explicit and implicit warranties with respect to the quality of a product. If a product fails to be of sufficient quality, and that failure is the cause of an injury to a purchaser who uses the product in a reasonable manner, the seller could be liable for breach of warranty. A plaintiff in a products liability lawsuit will typically cite multiple “theories” of liability in an attempt to maximize the odds of prevailing on at least one and thereby obtain a damages award (or a large settlement). The most commonly encountered theories of liability are negligence, strict liability, misrepresentation, and breach of warranty.

Even when a manufacturer exercises all possible care in attempting to build safe products, sometimes a product will nonetheless be shipped containing an unsafe defect. If that defect then causes injury to a user of the product, the manufacturer could be “strictly” liable for the resulting damages. The term “strict” is used because it removes the issue of manufacturer negligence from consideration, and instead is based on consumer expectations that products should not be unreasonably dangerous. Historically, and to a significant extent today, strict liability has been invoked with respect to manufacturing defects, design defects, and “failure to warn.” Also, product manufacturers have a duty to exercise a reasonable degree of care in designing their products so that those products will be safe when used in used in reasonably foreseeable ways. As a (very unlikely!) thought experiment, consider a manufacturer of fully automated (e.g., specifically designed so no driver intervention is needed) braking systems that, against all common sense, conducts testing using only vehicles driven on dry road surfaces. Then, if the braking systems prove unable to reliably avoid frontal collisions on wet roads, a person injured in a frontal collision on a rainy day could file a negligence claim. He or she could argue that his or her injuries were directly attributable to the manufacturer's negligent failure to anticipate driving in wet conditions as a reasonably foreseeable use of a car equipped with the fully automated braking system. Further, consider a manufacturer of fully autonomous vehicles that usually ships its cars with well-tested, market-ready automatic braking software. However, suppose that in one instance it accidentally ships one vehicle with a prototype version of the software containing a flaw not present in the market-ready version. If the vehicle becomes involved in an accident attributable to the flaw, a person injured in the accident could file a claim for damages arising from this manufacturing defect. A manufacturer can be found strictly liable for dangerous manufacturing defects, even if it has exercised “all possible care” in preparing the product.

The electronic risk measuring and scoring system provides motor or product liability (re-)insurance systems and/or risk-transfer systems related to or depending on partially or fully automated vehicles. Especially the extent to which a vehicle is automated and/or the extent to which the automated features are activated (e.g., level of automation, e.g., according to predefined definitions and categorizations, as e.g., given by the levels 1 to 5 of the NHTSA (US National Highway Traffic Safety Administration)). Thus, the electronic risk measuring and scoring system capable of providing an automated risk-transfer structure for diverging coverages to risk-exposed autonomous or partially autonomous driving motor vehicles, as e.g., product liability for car and/or technology manufacturer, driver liability cover, which is not possible with the prior art systems.

In one or more embodiments, the cyber risk data comprise risk of forward-looking accidents due to autonomous vehicle hacking. Cyber risk is defined as the risk of financial loss, disruption, or damage to the reputation of an organization from some sort of failure of its information technology systems. Cyber risks are dynamic in nature due to persistent digital innovations, intensifying global connectivity and the increasing sophistication of hackers. The fast pace of technological innovations, the potential for correlated risk exposure and the lack of historical claims data makes cyber-risk a complex phenomenon for insurers to underwrite. Commercial cyber security vulnerabilities pose risks including business interruption, breach of privacy and financial losses. However, with autonomous vehicles, the stakes are raised with the amplified threat of the loss of human life. As vehicles become more connected to their external environment, the number of attack surfaces and risk of vulnerabilities being exploited escalates. A growing research literature has identified autonomous vehicle's vulnerabilities and analyzed the potential impact of successful vulnerability exploitation while suggesting some mitigation measures.

In an example, the present system and method comprises probabilistic modelling structures to assess potential cyber losses. Compared with deterministic tools, these models look to quantify the full probability distribution of future losses instead of a single best estimate. In this sense, they are closer to traditional actuarial approaches to modelling risk. Sometimes referred to as cyber value-at-risk (VaR), these models provide a foundation for quantifying risk and instill discipline and rigor into the risk assessment process.

In other embodiments, score driving parameters are triggered and automatically selected based on defined score driving behavior pattern by comparing captured automotive data with the defined score driving behavior pattern. The score driving module can further e.g., automatically capture scores risks according to the measured location or trip of the motor vehicle based on the captured automotive data of the mobile telematics devices associated with the motor vehicles. This alternative embodiment has, inter alia, the advantage that it allows to provide a real-time adapted risk-transfer system. Further, it allows to capture and/or control the score driving behavior (also in the sense of location, time, road etc. of the used autonomous or partially autonomous driving) and compare its behavior within the technical operation and context. It allows to automatically capture score risks according to location or trip, and to automatically analyze and react on data related to the need of added services, as e.g., accident notifications).

In another embodiment variant, the system includes additional triggers triggering accident notification and/or other added services based on the captured automotive data of the automotive control circuits for autonomous or partially autonomous driving motor vehicle associated with the motor vehicles. This embodiment has, inter alia, the advantage that the present system and method are capable of providing additional benefit to the customer based on additionally generated signaling.

In other embodiments, the risk event triggers are dynamically adjusted based on time-correlated incidence data for one or a plurality of the predefined risk events. This embodiment has, inter alia, the advantage that improvements in capturing risk events or avoiding the occurrence of such events, for example, by improved forecasting systems, etc., can be dynamically captured by the present system and method, and dynamically affect the overall operation of the present system and method based on the total risk of the pooled risk exposure components.

In other embodiments, for processing risk-related component data and for providing measuring values regarding the likelihood of said risk exposure for one or a plurality of the pooled risk exposed, autonomous driving motor vehicles e.g. based on risk-related motor vehicles' data, the automated receipt and preconditioned storage of payments from the first resource pooling system to the second resource pooling system for the transfer of its risk can be dynamically determined based on the total risk and/or the likelihood of risk exposure of the pooled risk exposure components. This embodiment has, inter alia, the advantage that the operation of the present system and method can be dynamically adjusted to changing conditions of the pooled risk, such as changes of the environmental conditions or risk distribution, or the like, of the pooled risk components. A further advantage is the fact that the present system and method do not require any manual adjustments, when it is operated in different environments, places, or countries, because the size of the payments of the risk exposure components is directly related to the total pooled risk.

The present electronic risk measuring and scoring system and method provides a technical and automatable framework for risk transfer for autonomous vehicles (AVs). Although this disclosure has been described in terms of the risk transfer for the autonomous vehicles, it would be appreciated that teachings of the present disclosure may be applicable for any kind of assets for asset value risk-transfer, and not necessarily limited to autonomous vehicles. The inventive framework includes all necessary steps, comprising (a) asset component valuation, (b) risk assessment by ranked risks, inter alia, based on operational risks, contextual risks, tech performance, legal risks, and cyber risks, (c) benchmarking assets and asset risks by testing and simulations, (d) providing scores used for tariffication and risk-transfer modelling, and (e) using risk ranking to generate a global risk space with appropriate risk classes, and (f) streamlining/optimizing underwriting decisions.

The present electronic risk measuring and scoring system and method also provides means for reacting, in real-time, dynamically on captured motion, environmental or operational parameters of mobile telematics devise and/or motor vehicles during operation, in particular allowing a user to dynamically and in real-time adapt vehicle's operation or driving risks by means of an automated risk-transfer framework allowing to dynamically select appropriate usage-based risk-transfer profiles based on monitoring, capturing and reacting on automotive parameters of motor vehicle during operation or the physical condition of the user based on the user-specific parameters. More particularly, the present electronic risk measuring and scoring system and method extend the existing technology to a dynamic triggered and dynamically adjustable, risk-transfer system based on a dynamic adaptable or even floating risk-transfer, thereby reinforcing the importance of developing automated systems allowing self-sufficient, real-time reacting operation.

The present electronic risk measuring and scoring system and method further provides a way to technically capture, handle and automate dynamically adaptable, complex, and difficult to compare risk transfer structures by the user and trigger operations that are related to automating optimally shared risks and transfer operations. The present electronic risk measuring and scoring system and method further seek to dynamically synchronize and adjust such operations to changing environmental or operational conditions by means of telematics data invasive, harmonized use of telematics between the different risk-transfer systems based on an appropriate technical trigger structure approach, thus making the different risk-transfer approaches comparable.

The present electronic risk measuring and scoring system can, e.g., automatically capture score risks according to a measured maintenance status (e.g., maintenance failure by owner) and a surveillance factor extracted from the automotive data associated with the motor vehicle or the use of active safety features. The telematics-based feedback means of the system may, e.g., comprise a dynamic alert feed via a data link to the motor vehicle's automotive control circuit, wherein the central, expert system-based circuit signals device alerts drivers immediately to a number of performance measures, including, e.g., high RPM, i.e., high revolutions per minute as a measure of the frequency of the rotation of the motor vehicle's engine, unsteady drive, unnecessary engine power, harsh acceleration, road anticipation, and/or ECO drive and/or harsh braking and/or fast lateral road entries and/or left and right overtaking and/or tailgating and/or speeding/reckless driving (e.g., overtaking ahead of curves) and/or running red lights (vehicle-to-infrastructure (V2I) technology) and/or unsafe lane changes and/or wrong-way driving and/or distraction (more accurate with connected car data) and/or driving while drowsy, etc. The electronic risk measuring and scoring system provides opportunities for risk-adaption and improvement dynamically and in real-time, i.e., as and when they happen, related to the motor vehicle's risk patterns (e.g., location, speed, etc.). Providing instant feedback to drivers through heads-up training aids and information that is sent straight to the mobile telematics device, ensures a two-pronged approach to correcting risky (and often expensive) driving habits.

The present electronic risk measuring and scoring system can further provide the risk exposure for one or a plurality of the pooled risk-exposed motor vehicles based on the captured risk-related telematics data providing the likelihood of the occurrence of the predefined risk events of the pooled motor vehicles. In addition, the occurred and triggered losses can be automatically aggregated by means of captured loss parameters of the measured occurrence of risk events over all risk-exposed motor vehicles within a predefined time period by incrementing an associated stored aggregated loss parameter and, for automatically aggregating the received and stored payment parameters overall risk-exposed vehicles within the predefined time period, by incrementing an associated stored, aggregated payment parameter.

The present electronic risk measuring and scoring system not only allows for optimizing the operational parameters, but also optimizes the risk and/or risk behavior on the level of the risk-exposed motor vehicles. No prior art system offers such an integral optimization in real time. As another value-added service, the automotive car system can, e.g., dynamically generate fleet risk reports of selected motor vehicles. Such fleet reports, automatically generated by the automotive car system, provide a new approach to sharing and comparing vehicles' statistics. The proposed invention with, e.g., prefunding automotive enabled risk transfer ((re)insurance) means will motivate carriers to provide automotive data and claims' histories to the risk transfer system in order to continually improve the scoring service, which in turn benefits carriers in helping reduce costs and the combined ratio between the systems.

Thus, the present invention is capable of providing an automated risk transfer system for all kinds of risk transfer schemes, such as, e.g., motor or product liability (re-) insurance systems and/or risk-transfer systems related to or depending on partially or fully automated vehicles. Also, the present invention provides a holistic and unified, automated technical approach for coverage of the motor vehicles in all different structures of the risk transfer, such as, e.g., product liability for car and/or technology manufacturers and driver liability coverage. Further, the present invention also provides a holistic technical solution that covers the whole range from automotive control circuits and/or telematics devices and/or app installations to automated and accurate risk measurement, analysis, and management. Finally, it is capable of providing dynamic real-time scoring and measurements, and, furthermore, provides a technically scalable solution based on scoring algorithms and data processing that allows for the adaptation of the signaling to other fields of automated risk transfer. The present invention, which is enhanced by contextual data, is capable of providing the best and highest optimized technical solution to the real-time adapted risk transfer systems. It allows for automatically capturing risk scores according to location or trip, and for automatically analyzing and responding to data related to the need for value-added services, such as, e.g., accident notifications and/or warnings/coaching feedback to the driver and/or automated fleet risk reporting and/or automated and dynamically optimized underwriting etc.).

To realize the present electronic risk measuring and scoring system and method, one or more data processing systems and/or computers may perform particular operations or actions by virtue of having software, firmware, hardware, or a combination of them installed on the system that in operation causes or cause the system to perform the actions. One or more executable codes may perform particular operations or actions by virtue of including executable instructions that, when executed by data processing apparatus, cause the apparatus to perform the actions.

According to the present invention, these objects are achieved, particularly with the features of the independent claims. In addition, further advantageous embodiments can be derived from the dependent claims and the related descriptions.

Other embodiment variants and advantages of the inventive system and/or method will become apparent from the following detailed description, taken in conjunction with the accompanying drawings, which illustrate by way of example the teachings of the disclosure, and are not restrictive.

### BRIEF DESCRIPTION OF THE DRAWINGS

The present invention will be explained in more detail below relying on examples and with reference to these drawings in which:

FIG. 1 shows a block diagram, schematically illustrating an exemplary architecture of an electronic risk measuring and scoring system for an autonomous vehicle, according to some embodiments.

FIG. 2 shows a diagram illustrating an exemplary vehicle with a telematics unit for determining route parameters in real-time, according to some embodiments.

FIG. 3 shows a block diagram, schematically illustrating an exemplary workflow for the electronic risk measuring and scoring system, according to some embodiments. It is to be noted, that capturing the AV valuation is an add-on condition provided by the interconnectivity of the present system, for example, to provide further granularity and insight to the clustering, if given by the provider system technically allow such granularity. However, the AV valuation can be realized as an integrated part of the inventive system 1. Where AV provider systems could become a more essential part, is a possible integration of the technical methodology that may rely on the possible captured AV providers' measuring and AV data, specifically, perception and detection data. However, the present inventive system 1 based on the inventive technical AV risk framework does comprise this already.

FIG. 4 shows a flow diagram, schematically illustrating an electronic risk measuring and scoring method for an autonomous vehicle, according to some embodiments.

### DETAILED DESCRIPTION OF THE PREFERRED EMBODIMENTS

Aspects of this disclosure are directed to the field of autonomous vehicle driving, and in particular to risk assessment in the field of autonomous vehicle driving or Advanced Driver-Assistance Systems (ADAS) systems. The present disclosure provides a single score measure, i.e. a risk score measure, reflecting the impact of ADAS, as equipping a vehicle, on loss or damage occurrence frequency and severity caused by measured accident events. Risk score measure according to the present disclosure, provides a technical measure for a measurable rating factor for automated signaling of electronically steerable risk-transfer systems, calibrated on a specific portfolio, i.e. a storable and definably preselected set of autonomous driving vehicles exposed to the possibility of an accident event physically impacting vehicle during operation of the vehicle, in particular by capturing the impact of ADAS in terms of measured physical damage or loss frequency and severity.

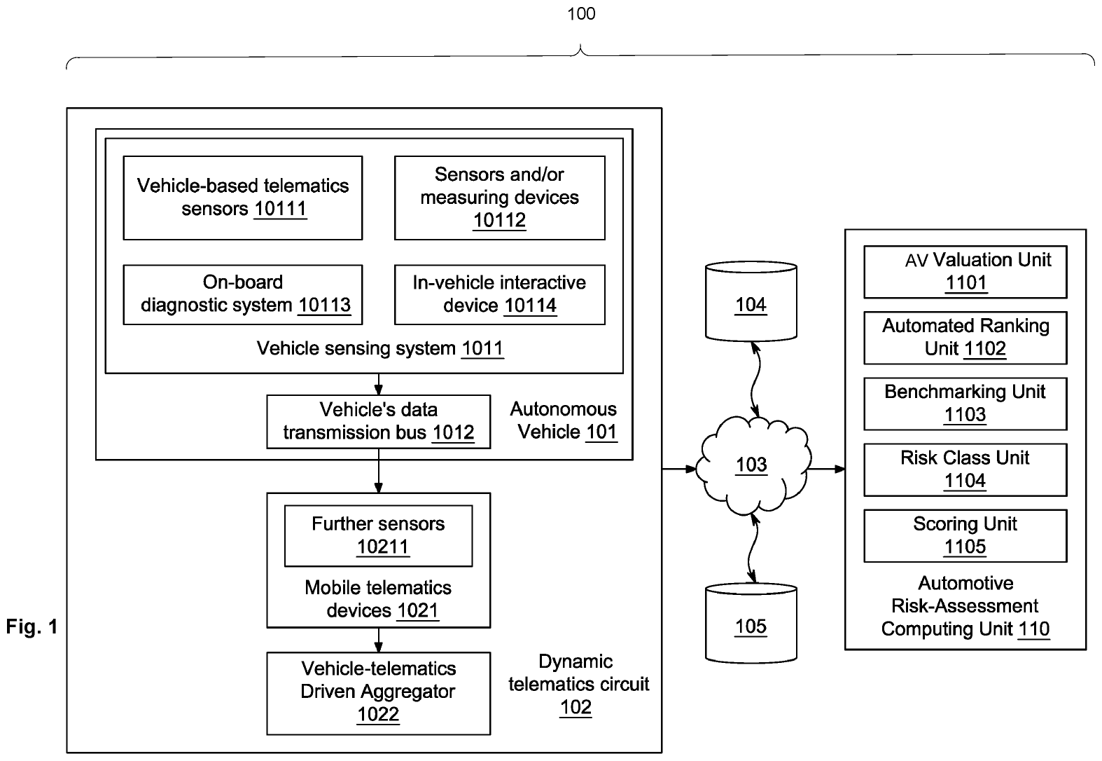

Referring to FIG. 1, illustrated is a block diagram of an electronic measuring and scoring system 100 (hereinafter, generally, referred to as “system 100”). The present system 100 is implemented for a motor vehicle, specifically an autonomous vehicle (generally represented by the reference numeral 101) provided with Advanced Driver-Assistance Systems (ADAS) features. Further, for the purposes of the present disclosure, the autonomous vehicle 101 (also referred to as “motor vehicle,” or simply as “vehicle” or “AV”) may be any suitable type of vehicle including, but not limited to, cars (including internal combustion engine-based cars, electric cars, or hybrid cars), buses, motorcycles, off-road vehicles, light trucks, and regular trucks, without any limitations. Herein, advanced driver-assistance systems (ADAS) denote groups of electronic technologies, in particular electronically driving support systems, that assist drivers in driving and parking functions. ADAS use automated steering, signaling processing, recognition and/or monitoring technology, such as sensors and cameras, to detect nearby obstacles or driver errors, and respond accordingly. Primarily, motor vehicles with ADAS features may detect certain objects, do basic classification, alert the driver of hazardous road conditions and, in some cases, automatically decelerate or stop the vehicle. By connecting the ADAS to a telematics system (as will be discussed later in the disclosure), it is possible to capture the vehicle events within a fleet system and implement a driver-monitoring program. ADAS features may include, but not limited to, adaptive cruise control, glare free high beam and pixel light, anti-lock braking system, automatic parking, automotive navigation system, automotive night vision, blind spot detection system, collision avoidance system, crosswind stabilization, intelligent speed adaptation, lane centering, lane departure warning system, lane change assistance system, surround view system, tire pressure monitoring, etc.

As illustrated, the system 100 includes a dynamic telematics circuit 102, also referred to as “telematics circuit” or sometimes “dynamic trip-detection telematics circuit”. The dynamic telematics circuit 102 represents collection of various telematics components used to monitor driving behavior, speed patterns, distance traveled and driving environment to assess the level of protection, and the like. Herein, the term “telematics” is used to describe vehicle onboard communication services and applications that communicate with one another via receivers and other telematics devices. For the purposes of the present disclosure, the telematics data captured may include, e.g., but not limited to, location, speed, idling time, harsh acceleration or braking, fuel consumption, vehicle faults, and more. When analyzed for particular events and patterns, this information may provide in-depth insights across an entire fleet. Further, as illustrated, the dynamic telematics circuit 102 includes mobile telematics devices 1021 (sometimes, referred to as “telematics devices”). The term ‘telematics device’ as used herein may generally refer to any appropriate device that is adapted to send, receive, and store information via telecommunication devices. In addition, the mobile telematics devices 1021 may be configured to store and/or send data associated with a condition of the vehicle 101. The mobile telematics devices 1021 may be adapted to be used with the vehicle 101. The mobile telematics devices 1021 may be in the form of plug-in or integrated vehicle informatics and telecommunication devices capable of remote communication. That is, the mobile telematics device 1021 may be an independently purchasable device that is configured to be attached to and/or detached from the vehicle 101 as desired. For example, the mobile telematics device 1021 may be attached to an onboard diagnostics (OBD) port of the vehicle 101 to receive data associated with the vehicle 101 from vehicle bus (such as, vehicle data transmission bus 1012, as discussed later). In another example, the mobile telematics devices 1021 may be integrated with the vehicle 101. For example, the mobile telematics device 1021 may be a Global Positioning System technology integrated with computers and mobile communications technology present in automotive navigation and internal network systems, such as OnStar®.

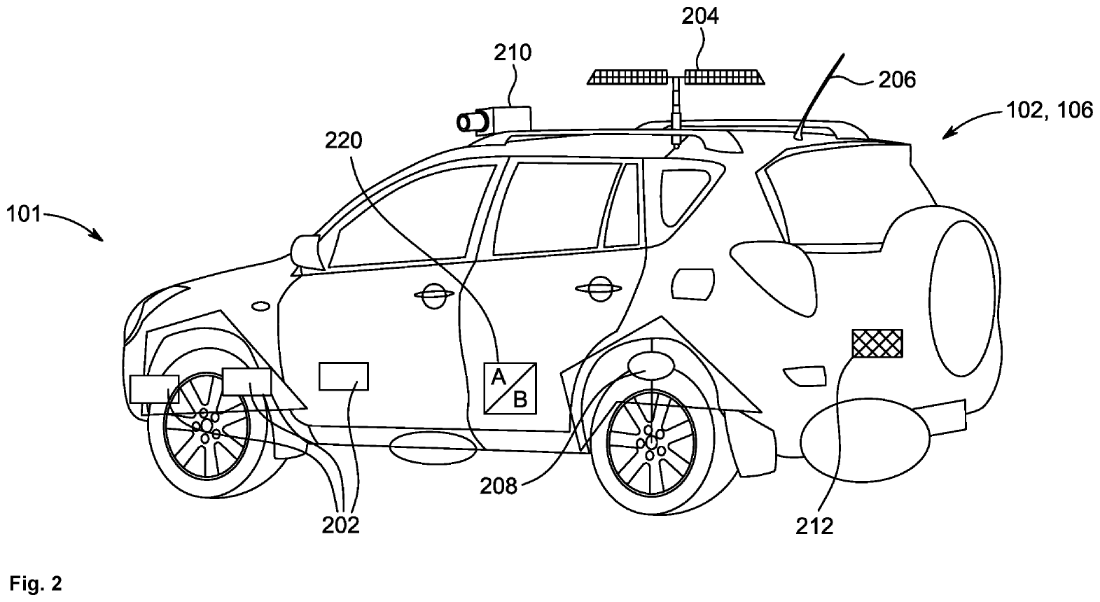

Further, as illustrated in combination with FIG. 2, in the present examples, a vehicle sensing system 1011 may be a part of the dynamic telematics circuit 102 of the vehicle 101. The vehicle sensing system 1011 may be disposed in signal communication with the mobile telematics devices 1021, in the dynamic telematics circuit 102. The vehicle sensing system 1011 may generally be defined to include all sensing means that may be part of the vehicle 101. The vehicle sensing system 1011 may include vehicle-based telematics sensors 10111, sensors and/or measuring devices 10112, on-board diagnostic system 10113 and in-vehicle interactive device 10114 (as shown in FIG. 1). The vehicle-based telematics sensors 10111 and sensors and/or measuring devices 10112 of the vehicle 101 may include proprioceptive sensors for sensing operating parameters of the motor vehicle and/or exteroceptive sensors for sensing environmental parameters during operation of the vehicle 101. The exteroceptive sensors or measuring devices may, for example, include at least radar devices 202 for monitoring surrounding of the vehicle 101 and/or LIDAR devices 204 for monitoring surrounding of the vehicle 101 and/or global positioning systems 206 or vehicle tracking devices for measuring positioning parameters of the vehicle 101 and/or odometrical devices 208 for complementing and improving the positioning parameters measured by the global positioning systems 208 or vehicle tracking devices and/or computer vision devices 210 or video cameras for monitoring the surrounding of the vehicle 101 and/or ultrasonic sensors 212 for measuring the position of objects close to the vehicle 101. The proprioceptive sensors (generally represented by reference numeral 220) or measuring devices for sensing operating parameters of the vehicles 101 may include motor speed and/or wheel load and/or heading and/or battery status of the vehicle 101, and the like. The vehicle sensing system 1011 may also include further sensors 10211, which may be part of the mobile telematics devices 1021. Such further sensors 10211 may include, but not limited to, a GPS module (Global Positioning System) and/or geological compass module based on a 3-axis teslameter and a 3-axis accelerometer, and/or gyrosensor or gyrometer, and/or a MEMS accelerometer sensor comprising a consisting of a cantilever beam with the seismic mass as a proof mass measuring the proper or g-force acceleration, and/or a MEMS magnetometer or a magnetoresistive permalloy sensor or another three-axis magnetometers. Further, the on-board diagnostic system 10113 is a computer system, generally, inside the vehicle that tracks and regulates a vehicle's performance. The on-board diagnostic system 10113 collects information from the network of sensors inside the vehicle 101, which the system may then use to regulate car systems or alert the user to problems. Also, the in-vehicle interactive devices 10114 are ubiquitous electronic devices provided in the vehicle 101 to provide valuable services to drivers and passengers, such as collision warning systems, assist drivers in performing the primary task in a vehicle that is driving; others provide information on myriad subjects or entertain the driver and passengers.

In an embodiment, the mobile telematics devices 1021 associated with the vehicle 101 comprise one or more wireless or wired connections, and a plurality of interfaces for connection with at least one of a vehicle data transmission bus (represented by the reference numeral 1012), and/or a plurality of interfaces for connection with sensors and/or measuring devices. The one or more wireless connections or wired connections of the mobile telematics devices 1021 may include Bluetooth (IEEE 802.15.1) or Bluetooth LE (Low Energy) as wireless connection for exchanging data using short-wavelength UHF (Ultra high frequency) radio waves in the ISM (industrial, scientific and medical) radio band from 2.4 to 2.485 GHz by building a personal area networks (PAN) with the on-board Bluetooth capabilities and/or 3G and/or 4G and/or GPS and/or Bluetooth LE (Low Energy) and/or BT based on Wi-Fi 802.11 standard, and/or a contactless or contact smart card, and/or a SD card (Secure Digital Memory Card) or another interchangeable non-volatile memory card. Herein, the data transmission may take place using standard wired network, including a fiber or other optical network, a cable network; or alternatively using wireless networks such as wireless local networks (WLANs) implementing Wi-Fi standards, Bluetooth standards, Zigbee standards, or any combination thereof. In particular, the mobile telematics devices 1021 may provide mobile telecommunication networks as, for example, 3G, 4G, 5G LTE (Long-Term Evolution) networks or mobile WiMAX or other GSM/EDGE and UMTS/HSPA based network technologies etc., and more particular with appropriate identification means as SIM (Subscriber Identity Module) etc.

The term ‘vehicle data transmission bus,’ as used herein may generally refer to any appropriate internal communications network of a vehicle that interconnects components inside the vehicle. The internal communications network of the vehicle 101 may allow micro controllers and devices such as engine control unit, transmission control unit, anti-lock braking system, body control modules, other sensors, etc., that are already present in the vehicle 101 to communicate with each other within the vehicle 101. The internal communication network, the micro controller, and the devices of the vehicle 101 may operate in concert to collect, handle, and maintain any appropriate data associated with a condition of the vehicle 101, such as fuel level data, brake fluid level, engine status, and so on. The different vehicle bus protocols may include, but are not limited to, Controller Area Network (CAN), Local Interconnect Network (LIN), Domestic Digital Bus (D2B), FlexRay, DC-BUS, IEBus, Media Oriented Systems Transport (MOST), SMARTwireX, and so on. In some examples, the data collected, handled, and/or maintained by the vehicle data transmission bus 1012 may be obtained by connecting to the vehicle bus via an on-board diagnostics (OBD) connector. One of ordinary skill in the art may understand and appreciate that the list of example devices, micro controllers, and data collected and maintained by the vehicles internal communication network is not exhaustive.

In present embodiments, for providing the wireless connection, the mobile telematics device 1021 acts as wireless node within a corresponding data transmission network by means of antenna connections of the mobile telematics device 1021. The mobile telematics devices 1021 may provide the one or more wireless connections by means radio data systems (RDS) modules and/or positioning system including a satellite receiving module and/or a cellular mobile device module including a digital radio service module and/or a language unit in communication the radio data system or the positioning system or the cellular telephone module. The satellite receiving module may include a Global Positioning System (GPS) circuit and/or the digital radio service module may include at least a Global System for Mobile Communications (GSM) unit. A data link may be set by means of the wireless connection of the mobile telematics devices 1021 over a mobile telecommunication network between the mobile telematics devices 1021 as client and the vehicle sensing system 1011. The mobile telematics devices 1021 act as wireless node within said mobile telecommunication network. Further, the plurality of interfaces of the mobile telecommunication apparatus for connection with at least one of a motor vehicle data transmission bus 1012 may include at least one interface for connection with a motor vehicle's Controller Area Network (CAN) bus, e.g., in connection with on-board diagnostics (OBD) port, or other connection e.g., for battery installed devices, or also OEM (Original Equipment Manufacturer) installed systems getting information access to on-board sensors or entertainment systems (as, for example, Apple Carplay, etc.) providing the necessary vehicle sensor information.

Further, in an embodiment, the mobile telematics devices 1021 are connected to the on-board diagnostic system 10113 and/or an in-vehicle interactive device 10114, wherein the mobile telematics devices 1021 capture usage-based and/or user-based and/or operational telematics data of the motor vehicle and/or user. The mobile telematics devices 1021 capture usage-based and/or user-based and/or operational telematics data of the motor vehicle and/or user, and transmit them via the data transmission network, in the dynamic telematics circuit 102. The mobile telematics devices 1021 are configured for capturing different kinds of telematics data, e.g., trips or trip segments and driving patterns from the motor vehicles and/or automation level of the motor vehicle (driving itself partially or fully autonomous (auto piloting)) and/or if the user is intervening with its automated or safety features. Such captured information may be stored in the form of logs including trip information logs, diagnosis logs, activity logs, location logs, user logs, and vehicle logs. In one example, the logs information associated with a vehicle, such as location of the vehicle, a heading direction of the vehicle, speed of the vehicle, distance traveled by the vehicle, a fuel level data of the vehicle, and so on. Further, the logs may include operating parameters and/or environmental parameters during operation of the motor vehicle, including time-dependent speed measuring, hard braking, acceleration, cornering, distance, mileage (PAYD), short journey, time of day, road and terrain type, mobile phone usage (while driving), weather/driving conditions, location, temperature, blind spot, local driving, sun angle and dazzling sun information (sun shining in drivers' face), seatbelt status, rush hour, fatigue, driver confidence, throttle position, lane changing, fuel consumption, VIN (vehicle identification number), slalom, excessive RPM (Revolutions Per Minute), off road, G forces, brake pedal position, driver alertness, CAN (Controller Area Network) bus (vehicle's bus) parameters including fuel level, distance to other vehicles, distance to obstacles, driver alertness, activated/usage of automated features, activated/usage of Advanced Driver Assistance Systems, traction control data, usage of headlights and other lights, usage of blinkers, vehicle weight, amount of vehicle passengers, traffic sign information, junctions crossed, jumping of orange and red traffic lights, alcohol level detection devices, drug detection devices, driver distraction sensors, driver aggressiveness, driver mental and emotional condition, dazzling headlights from other vehicles, vehicle door status (open/closed), visibility through windscreens, lane position, lane choice, vehicle safety, driver mood, and/or passengers' mood.

In the present system 100, the mobile telematics devices 1021 are associated with a plurality of cellular mobile devices (not shown). Herein, the mobile telematics device 1021 may be at least partially realized as part of cellular mobile device. The mobile cellular devices may also include one or more data transmission connection to vehicle-based telematics sensors 10111, sensors and/or measuring devices 10112, on-board diagnostic system 10113 and/or in-vehicle interactive device 10114 of the motor vehicle. As may be appreciated, modern cellular mobile devices, like smartphones (with the two terms being interchangeably used), are more than calling devices, and incorporate a number of high-end sensors. With this, the use of smartphones may be extended from the usual telecommunication field to applications in other specialized fields including transportation. Sensors embedded in the smartphones like GPS, accelerometer and gyroscope may collect data passively, which in turn may be processed to infer the travel mode of the user. Because of GPS sensors being embedded into almost all modern smartphones, it becomes possible to replace the GPS data loggers being used previously which are generally considered a burden to carry around. Smartphones have an added advantage of being a necessary travel companion, hence being able to monitor the travel patterns over extended periods of time. In addition, GPS enabled smartphones are also utilized for indoor positioning and pedestrian navigation. Further, the inclusion of accelerometer in smartphones has dramatically enhanced its capability to accurately detect the travel mode and trip purpose. Accelerometer may detect accelerations along three axes (x, y, and z) with respect to the gravitational force. It means that at rest, the accelerometer will register an acceleration of 9.8 m/s2 along the downward direction. Orientation augments the accelerometer data by providing the information regarding angular motion. Orientation sensors are often software-based and drive their data from the accelerometer and the geomagnetic field sensor. Parameters including data frequency, moving temporal window size and proportion of data to be captured, are dealt with to achieve better results. For the purposes of the present disclosure, the mobile telematics devices 1021 may perform trip and trip segments detection as well as travel mode detection using the continuous flow of sensory data from the GPS sensor, the accelerometer and orientation sensor collected by smartphones.

In an embodiment, GPS points of the sets of motion status signals are at least partially enriched by measured additional sensory data measured by further sensors of the mobile telematics device 1021 and/or by sensory data measured by vehicle-based telematics sensors 10111 at any stage before transferring the sets of motion status signals to the mobile telematics device 1021. As discussed, the sensors and measuring devices 10112 of the mobile telematics device 1021 or the smart phone may include an accelerometer sensor or measuring device and a gyroscope sensor or measuring device and a Global Positioning System (GPS) sensor or measuring device. In an example, for the sensing phase, the frequencies for which the sensors may be logged are, for example, 1 Hz for the Global Positioning System (GPS) sensors and 50 Hz for accelerometers and gyroscopes. Each measure of location data is captured in association with a time stamp. Thus, for trips and/or trip-segments identification, each measurement of the instantaneous movement telematics data is captured and assigned to a measured time stamp by means of a polling device, wherein the measurements of the telematics data are provided in an interval sensing within a defined time interval between two sensing steps. Before analyzing the data, the captured data need to be brought into a format that may be understood by the ad-hoc classifier module. The measurements stream may be chunked into windows of 1 second. Since acceleration data is expected to be sampled at 50 Hz, each window will consist of approximately 50 acceleration measurements with 3 dimensions and a time stamp each and approximately one GPS coordinate pair together with a timestamp. This is due to the fact that the actual sampling is implementation-dependent and only accessible on the hardware level. Each chunk is then treated individually as soon as it may be computed. After getting the needed format, as described above, the most likely components may be approximated by turning the acceleration axes of the mobile device into the axes of the actual movement, thus getting a more thoroughly rotated system of reference. The input of the operation consists of the acceleration vector only and may return rotated acceleration vectors of the same format.

In the present disclosure, the dynamic telematics circuit 102 is implemented to aggregate telematics data from the mobile telematics devices 1021 associated with the vehicle 101. For this purpose, as illustrated, the dynamic telematics circuit 102 includes a vehicle-telematics driven aggregator 1022. The present vehicle-telematics driven aggregator 1022 is adapted to cope with the physical limits of the cellular mobile devices in order to minimize both the information loss (potential car-relevant data) and the battery consumption. The vehicle-telematics driven aggregator 1022 may provide the technical structure to allow implementation of appropriate logging strategies with defined measure and/or metric and/or KPI metrics. A measure herein is a defined technical and physically measurable quantification or indexing. A metric herein is a measure as a fundamental or unit-specific term but is beyond that directed performance directed measures. KPIs (Key Performance Indicator) are relevant measurable performance metrics that are measurable to the operation of devices or the same. Typically, KPIs are determined measuring over a specified time period, and compared against acceptable norms, past performance metrics or target measurement. For the risk measurement and risk scoring measurement, the dynamic telematics circuit 102 may configure the vehicle-telematics driven aggregator 1022 with telematics data-based triggers, triggering, capturing, and monitoring in the dataflow pathway of the vehicle-based telematics sensors 10111, the sensors and/or measuring devices 10112, the on-board diagnostic system 10113 and/or the in-vehicle interactive device 10114 of the motor vehicle, including sensory data of the sensors of the mobile telematics device 1021 and/or operating parameters and/or environmental parameters during operation of the motor vehicle.

The vehicle-telematics driven aggregator 1022 for the mobile telematics devices 1021 may be configured to provide instantaneous movement telematics data as measured by and logged from sensors of the mobile telematics devices 1021 and trips and/or trip-segments based on the instantaneous movement sensory telematics data as automatically identified and detected. This is possible as the telematics data include usage-based and/or user-based and/or operation-based sensory data, and at least include sensory data from the accelerometer sensor, the gyroscope sensor, and the Global Positioning System (GPS) sensor, assigned with respective time stamps. The access to the sensors may be made available in different ways depending on the operating system. For example, for Android-based mobile smart phone devices, Android allows the implementation of listeners over the sensors. As another example, for iOS-based mobile smart phone devices, iOS of Apple allows the logging of the sensors only when a significant change in the GPS position is observed. It is to be noted that per se the operation to monitor such condition doesn't drain battery amperage in the iOS because the device stores GPS position via physical motion co-processor. Android doesn't provide an API (Application Programming Interface) to interact with motion co-processor of the device (thus different chips might work in a different way). Under APIs, typically a set of commands provide that may be used to access specific functionality of the underlying operating system (OS) or hardware device. For example, in this case, the cellular mobile devices might have a specific API that allows interacting with the motion co-processor of the device, or not. This drawback sometimes may be overcome. For example, a significant position change mechanism might be implemented via software in Android, but unfortunately the switch on operation of the GPS chip requires a lot of power which can drain the battery. It is further to be noted, that GPS's battery draining behavior is most noticeable during the initial acquisition of the satellite's navigation message: the satellite's state, ephemeris, and almanac. Acquiring each satellite takes 12 to 30 seconds. It is to be noted, that, for feature extraction, it may be preferable to add additional information with regards to the features to be extracted, wherever necessary. For example, the fast discrete Fourier Transform (FFT) is an efficient way to obtain the frequency modes of the time windows. Since most implementations opt for the most efficient algorithm that always treats time series in powers of two (i.e., sequences of length 2, 4, 8, 16, . . . ), the time series have to be analyzed on the base of 64 measurement points: For a window size of 1 second and a sampling frequency of 50 Hz, 50 samples of acceleration values are obtained. This sequence is to be filled with zeros such that the input of the FFT consists of the necessary 64 numbers, in order to avoid variations in actual numerical scope.

Also, as shown in FIG. 1, the system 100 further comprises a first database 104 configured to store vehicle representative technologies and vehicle data. The first database 104 may be disposed in communication with autonomous vehicle providers (manufacturers) (not shown in FIG. 1) to fetch information about vehicle representative technologies and vehicle data associated with the autonomous vehicle 101. Herein, the vehicle representative technologies and vehicle data may include a vehicle component modelling structure for the autonomous vehicle 101 which may be used for performing simulations and testing of performance of the autonomous vehicle 101, including testing of ADAS of the autonomous vehicle 101. The system 100 further comprises a second database 105 configured to store vehicle history data. The first database 104 may be disposed in communication with vehicle registration service providers, risk-related telematics providers and/or other telematics monitoring system providers or the like (not shown in FIG. 1) to fetch measuring data about vehicle history data associated with the autonomous vehicle 101. Herein, the vehicle history data may include data and/or measured parameter values about at least one of age of the autonomous vehicle, health of engine of the autonomous vehicle, distance traveled by the autonomous vehicle, service history of the autonomous vehicle, and accident history of the autonomous vehicle.

The electronic modelling structure can e.g. be based on a logistic regression model structure for determining and/or measuring and/or predicting the statistically significant factors that affect crash severity for the vehicles (101) to ICEV vehicles. However, the predictive modelling structure can e.g. also be based on an artificial intelligence or machine-learning based modelling structure. To forecast the crash severity, further, the following measuring values, in particular contextual measuring parameters, can be used, for example, as further input parameters to the electronic modelling structure (further to the operational and/or architectural vehicle data), listed in the below table used for crash severity measurement and forecasts:

| | | | |
|---|---|---|---|
| | | ICEV | EV/AV/ |
| Variable | Definition | (%) | ADAS (%) |

Dependent

| | | | |
|---|---|---|---|
| Severity | 0 if light crash | 84.7 | 86.7 |
| | 1 if severe crash | 15.3 | 13.3 |

Independent

| | | | |
|---|---|---|---|
| Weekend | 0 if it occurred on weekdays | 76.1 | 82.4 |
| | 1 if it occurred on weekends | 23.9 | 17.6 |
| Time of day | AM peak (7-8 a.m.) | 10.2 | 16.2 |
| | Daytime (9 a.m.-2 p.m.) | 32.4 | 29.1 |
| | PM peak (3-5 p.m.) | 26.4 | 31.7 |
| | Nighttime (6 p.m.-6 a.m.) | 31.1 | 23.0 |
| Settlements | Urban area | 37.3 | 56.1 |
| | Rural area | 62.7 | 43.9 |
| Speed limit | Low speed (<50 km/h) | 13.7 | 21.6 |
| | Middle speed (≥50 and <80 km/h) | 52.9 | 59.4 |
| | High-speed (≥80 km/h) | 33.4 | 19.1 |
| Roadway | Segment | 63.4 | 44.6 |
| location | Junction | 36.6 | 55.4 |
| Presence | No | 89.5 | 82.4 |
| of medians | Yes | 10.5 | 17.6 |
| Visibility | Good visibility | 79.8 | 78.4 |
| | Good visibility-rainfall/snowfall | 14.3 | 15.1 |
| | Poor visibility | 5.9 | 6.5 |
| Road surface | Dry | 59.3 | 58.6 |
| conditions | Wet | 25.1 | 32.4 |
| | Snowy/icy | 15.6 | 9.0 |
| Accident | Car | 64.0 | 55.8 |
| category | Motorcycle | 16.2 | 11.5 |
| | Bike/pedestrian | 19.8 | 32.7 |

The table above lists a summary of possible variables used in regression or machine-learning structure to measure crash severity. Some variables are recategorized to balance sample sizes in each category without losing the representativeness. As embodiment variant, only crashes with definite values for these variables can be adopted, for example, occupying essentially 80% and also essentially 80% of the raw measuring data, respectively. In this example, the explanatory measuring parameters mainly include time factors (day of week, time of day), location factors (settlements, speed limit, roadway location, and the presence of median), environmental factors (visibility and road surface conditions), and crash partner factors (accident category). Based on a loop-back link, variables can e.g. be redefined, which may be preferable for more complex applications. For time indicators, day of week can e.g. be reclassified into weekday and weekend to reflect distributions of crashes on weekdays and weekends; time of day can e.g. be reclassified into four types: AM peak (7-8 a.m.), daytime (9 a.m.-2 p.m.), PM peak (3-5 p.m.), and nighttime (6 p.m.-6a.m.), to reflect and capture measuring distributions of crashes over hours; for accident category, bike and pedestrians can e.g. be merged as non-motorized objects.

According to embodiments of the present disclosure, the system 100 further comprises an automotive risk-assessment computing and/or risk-monitoring and/or risk-measuring unit 110. As shown in FIG. 1, the automotive risk-assessment computing unit 110 is decentrally connected to the dynamic telematics circuit 102 over a data transmission network 103. The automotive risk-assessment computing unit 110 is configured to process the telematics data to generate scores or indices (hereinafter referred to as “risk score”), to calibrate and rate and/or price risk-transfers, and/or as input for risk-transfer modeling for the autonomous vehicle 101. Herein, risk score indicates an impact of ADAS features to an accident risk associated with the vehicle 101. Risk score measure relates to measuring systems in the field of autonomous vehicle driving, in particular to risk assessment in the field of autonomous vehicle driving or ADAS systems. The measured risk score value is a measurable, technical risk-transfer rating factor, calibrated on a specific set of selected autonomous vehicles (sometimes also referred to as portfolio of vehicles), the factor capturing the impact of ADAS in terms of measured damage or loss frequency and severity associated with measured physical accident events, i.e. having a precise occurrence in time, location, and impact to involved vehicles from the preselected set of vehicles. The risk score measure may inter alia be used for: (1) Portfolio profitability analysis and (2) Underwriting factor. In the Portfolio Profitability Analysis, the score allows to provide insights into the client's exposure to ADAS (descriptive analytics) as well as a set of advanced portfolio analyses highlighting the enhanced predictive power of a motor risk model. The present system 100 allows to provide potential impacts based on the risk score on the client's insurance tariff and pricing strategy. In the Underwriting Factor, the risk score may be provided at point of quote. Through the present system 100, the risk score may be provided globally, at vehicle level and easily accessible in near-real time. No raw vehicle specifications are provided through the risk score. Instead, the risk score provides a single score measure, i.e., the risk score, reflecting the impact of ADAS, as equipping a vehicle, on insurance claims frequency and severity. The system 100 may distinguish between cover-types (MOD/MTPL) when providing the risk score. The risk score, as provided by the system 100, bridges the gap and provides the insurance technology with the missing piece of information using technological and scientific methodology.

Further, the automotive risk-assessment computing unit 110 is configured to calibrate a user-specific rated risk-transfer, wherein the user-specific rated risk-transfer defines an impact of ADAS features in measures of risk-transfer claims frequency and severity. That is, the present system 100 performs calibration for a specific market or technological automobile segment, vehicle testing at single sensor level and simulations. This combination provides an unmatched resolution allowing to evaluate and differentiate ADAS features with respect to car manufacturers, car models and technological evolutive steps. In turn, this leads to much more accurate pricing predictions and risk model structures for risk-transfer systems and closed-loop feedbacks to OEMs in terms of real effectiveness of their systems in real traffic situations. This is possible from a technological and scientific interaction with car manufacturers where vehicles' build data are processed through the present system 100. For the risk-measuring by the automotive risk-assessment computing unit 110, dynamically measured and detected tips and/or trip segments may, for example, be used to perform an output signal generation based upon detected tips and/or trip segments and/or further risk measure parameters and/or crash attitude measure parameters. The automotive risk-assessment computing unit 110 is able to react in real-time, dynamically on captured motion and/or environmental measuring parameters, in particular on monitored and captured telematics parameters of the mobile telematics devices 1021 during motion or movement of the mobile telematics devices 1021. In addition, the measured risk score may be easily applied to risk modelling structures of other automated risk-measuring system 110. Thus, the automotive risk-assessment computing unit 110 enables to measure and assess effectiveness of the autonomous vehicle 101 to accurately reflect its impact on vehicle safety.

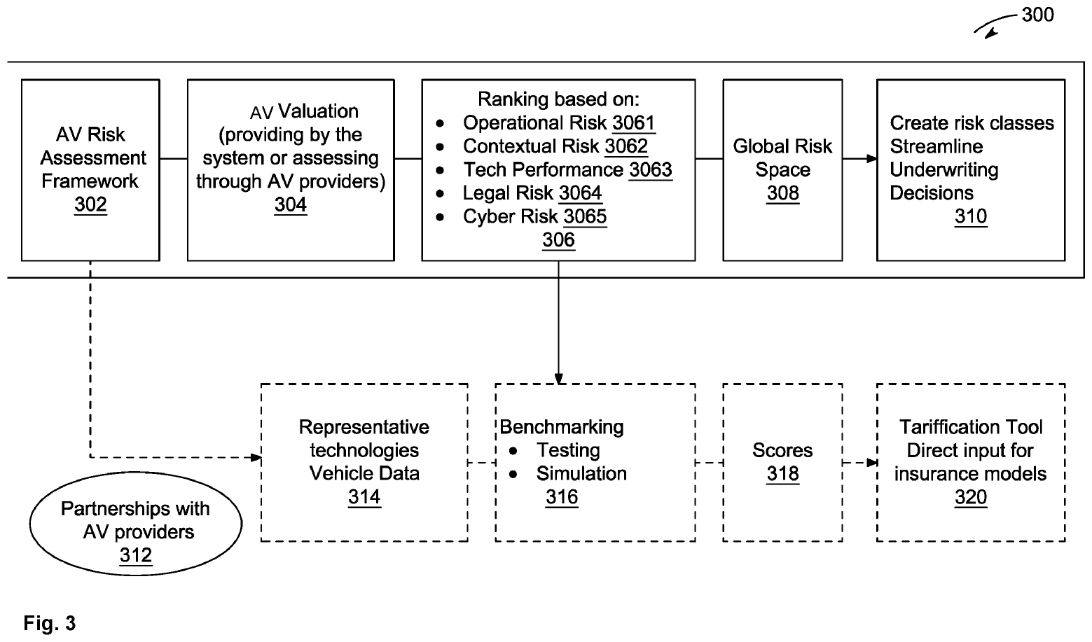

FIG. 3 provides a workflow (as represented by reference numeral 300) implemented by the automotive risk-assessment computing unit 110 of FIG. 1. In particular, the automotive risk-assessment computing unit 110 implements autonomous vehicle risk assessment framework 302 of the workflow 300 as described hereinafter. Further details of the automotive risk-assessment computing unit 110 has been described in conjunction with the workflow 300, and in particular with autonomous vehicle risk assessment framework 302 of the workflow 300 in the proceeding paragraphs.

For the purposes of the present disclosure, as shown in FIG. 1, the automotive risk-assessment computing unit 110 of the electronic risk measuring and scoring system 100 comprises a vehicle component valuation unit 1101 to valuate the technical components of the autonomous vehicle 101. In a risk-transfer context, vehicle component valuation is required to assess the market value of the vehicle components to ensure that adequate cover by a risk-transfer system can be assigned. Autonomous vehicle components include the vehicle components as such and the autonomous driving components that enable autonomous driving comprising (i) sensors, (ii) semiconductors, and (iii) operating and steering software, data processing means and signaling devices. Sensors, including cameras, Light Detection and Ranging (LiDAR), and radar are used together to help vehicles see road conditions at various distances, and in different weather and lighting conditions. The autonomous-driving components can e.g. be classified into electronic scene recognition, path planning, and vehicle control means. Each class can comprise a set of sophisticated algorithms. For instance, scene recognition requires localization, object-detection, and object-tracking data processing structures. Path planning often falls into mission and motion planning, whereas vehicle control corresponds to path following.

In the present system, the autonomous vehicle component valuation can be provided by autonomous vehicle providers and/or autonomous vehicle valuation providers, or it is imaginable, that it is provided by the system itself, for example, based on empirical data of risk-transfer systems and loss adapters in the process of evaluating reinstatement costs after a loss, or by automated filter processes capturing and/or updating relevant components data of accessible network databases or the like. Such autonomous vehicle valuation data are, thus, assessed or provided within the present inventive system by evaluating all types of autonomous vehicle components, as described above. Further, the vehicle component valuation process may be enabled to not only automatically assess the monetary amount equivalent value of the possible physical loss to be covered prior to providing cover, but also following losses in order to determine settlement amounts. The system can also be enabled to determine monetary equivalent values at a given time in the past by providing appropriate time series values, for example, by providing an accurate valuation of damaged equipment that e.g. was affected by flooding several years in the past. Where no useful or relevant data (e.g. of recent market transactions) are assessable which can be used to value a vehicle component, the solution can e.g. use DRC (Depreciated Replacement Cost) methods and/or data processing structures to determine the accurate value of an autonomous vehicle component.

In an embodiment, the electronic risk measuring and scoring system 100 for the autonomous vehicle 101 is characterized in that the vehicle component valuation unit 1101 performs valuation of the autonomous vehicle 101 based on at least one of age of the autonomous vehicle, health of engine of the autonomous vehicle, distance traveled by the autonomous vehicle, service history of the autonomous vehicle, and accident history of the autonomous vehicle. In an example, the autonomous vehicle risk assessment framework 302 of the workflow 300 allows for partnerships with the autonomous vehicle providers (manufacturers) (as represented by reference numeral 312 in the workflow 300 of FIG. 3) to get access to vehicle data (as represented by reference numeral 314 in the workflow 300 of FIG. 3) for fetching required information, including age of the autonomous vehicle, health of engine of the autonomous vehicle, distance traveled by the autonomous vehicle, service history of the autonomous vehicle, and accident history of the autonomous vehicle, to perform the necessary valuation of the autonomous vehicle 101 (as represented by reference numeral 304) based thereon. As discussed earlier, the vehicle data may be fetched and stored in the second database 105, from which the vehicle component valuation unit 1101 may be able to that data, as required, for performing valuation of the autonomous vehicle 101.

In an example, the vehicle component valuation unit 1101 uses registration data of the vehicle 101 and processes (i) motor vehicle pricing data to identify book prices corresponding to types of motor vehicles (e.g., as identified in the registration data) and (ii) motor vehicle auction data to identify auction prices corresponding to the types of motor vehicles. Based on the book prices and auction prices, the electronic risk measuring and scoring system generates a report with the valuation of the vehicle 101. In some embodiments, the auction price for the vehicle 101 may be the average auction price of all the motor vehicles sold at auction corresponding to that type (e.g., excluding “salvage” or “as-is” auctions). In some embodiments, the book price for the vehicle 101 may be determined based on the average mileage of all the motor vehicles sold at auction corresponding to that type, a base book price for that type of motor vehicle, and at least one mileage adjustment factor. If the average mileage for the vehicle 101 is above or below an expected mileage, the electronic risk measuring and scoring system will decrease or increase the valuation for the vehicle 101 by an amount indicated in the at least one mileage adjustment factor. In some embodiments, if the average mileage for that type of motor vehicle is within an expected mileage, or if the electronic risk measuring and scoring system does not consider mileage in determining the book price, the electronic risk measuring and scoring system may set the book price to be the base book price. As embodiment variant, the autonomous vehicle valuation unit 1101 can e.g., automatically capture scores risks according to a measured maintenance (e.g., maintenance failure by owner) and surveillance factor extracted from the automotive data associated with the autonomous or partially autonomous vehicle and/or the control systems or the use of active safety features. In another example, the autonomous vehicle valuation unit 1101 gives consideration to residual value forecasting procedures including (1) collecting transaction data of the goods classified in a same category, (2) extracting the elapsed time and residual value (secondhand price) at the time of transaction from the respective transaction data, (3) approximating the function against the extracted data (elapsed time, residual value), and (4) forecasting the residual value in a prescribed future based on such approximate function. Upon designing a residual value risk-transfer based on the forecasted residual value, a step of (5) designing the residual value insurance based on the forecasted residual value (calculation of insurance premium) is added to the procedures.

Further, the automotive risk-assessment computing unit 110 of the electronic risk measuring and scoring system 100 comprises an automated ranking unit 1102 for determining ranking associated with forward-looking accident frequencies and severities for the autonomous vehicle based on the valuation thereof (as described in the proceeding paragraphs), and at least on one of operational risk data 3061, contextual risk data 3062, technical performance of autonomous vehicle 3063, legal risk data 3064 and cyber risk data 3065 therefor (as represented in the workflow 300 of FIG. 3 and described in detail further in the description). In an example, the autonomous vehicle risk assessment framework 302 of the workflow 300 allows for partnerships with the autonomous vehicle providers (manufacturers) 312 to get access to vehicle representative technologies and vehicle data 314 for fetching required information for the autonomous vehicle 101 to determine the operational risk data 3061, the contextual risk data 3062, the technical performance of autonomous vehicle 3063, the legal risk data 3064 and the cyber risk data 3065 therefor, in order to determine ranking of the autonomous vehicle 101 (as represented by reference numeral 306 in the workflow 300 of FIG. 3).

As may be appreciated that most statistical analyses of accidents are based on either frequency or severity or both. The standard frequency rate represents the number of disabling injuries for given man-hours of exposure. The standard severity rate is the total time charged as a result of lost time injury for a given number of man-hours of exposure. Thus, the frequency rate indicates how many injuries are occurring in relation to number of hours driven in case of the autonomous vehicles and the severity rate indicates how severe those injuries, due to accidents, are. The objective is to reduce both the frequency with which accidents occur and the frequency with which they threaten. It may be appreciated that frequency and severity rate vary from one autonomous vehicle to another autonomous vehicle. These differences reflect not only the inherent differences in the autonomous vehicles from different manufacturers but also many other factors including the efficiency of such different autonomous vehicles. Herein, frequency-severity method is an actuarial method for determining the expected number of claims that an insurer will receive during a given time period and how much the average claim will cost. Frequency-severity method uses historical data to estimate the average number of measured occurred losses or damages and the average cost value providing an abstract equivalent measured for the actual occurred physical damage/loss to the vehicle. The method multiplies the average number of losses (sometime referred to as claims) by the average monetary cost equivalent of an occurred loss/damage. In the frequency-severity method, frequency refers to the number of occurred losses/damages of a portfolio that a forecast system predicts or simulates for occurring in a given future period of time. If the frequency is high, it means that a large number of losses is forecasted to occur. Severity can e.g. refer to the size of the damage and/or to the monetary equivalent given by the cost to cover an occurred damage to a vehicle. A high-severity damage is more expensive than an average damage, and a low-severity damage is less expensive than the average damage. Average monetary cost equivalent values of actual occurring damages can e.g. be forecasted based on historical data and/or measured values of the average monetary cost equivalent values can be calibrated by it.

In one or more embodiments, the electronic risk measuring and scoring system 100 for the autonomous vehicle 101 is characterized in that the operational risk data 3061 comprises risk due to forward-looking accidents due to operations of the autonomous vehicle 101. Herein, the automated ranking unit 1102 generates by data processing the operational risk data 3061 which provides the accident risk factor for the vehicle 101 that may be determined for the autonomous or semi-autonomous vehicle technology and/or the autonomous or semi-autonomous driving package of computer instructions based upon an ability of the autonomous or semi-autonomous vehicle technology and/or computer instructions to avoid collisions without human interaction. The ability to avoid collisions without human interaction may further correspond to one or more of the following: (1) a type of the autonomous or semi-autonomous vehicle technology, (2) a version of computer instructions of the autonomous or semi-autonomous vehicle technology, (3) an update to computer instructions of the autonomous or semi-autonomous vehicle technology, (4) a version of artificial intelligence associated with the autonomous or semi-autonomous vehicle technology, and/or (5) an update to the artificial intelligence associated with the autonomous or semi-autonomous vehicle technology. Additionally, the received information regarding at least one of (1) the autonomous or semi-autonomous vehicle technology or (2) the accident-related factor may include at least one of a database or a model of accident risk assessment, which may be based upon information regarding at least one of (a) past vehicle accident information or (b) autonomous or semi-autonomous vehicle testing information. Moreover, the accident-related factor may be related to at least one of the following: a point of impact; a type of road; a time of day; a weather condition; a type of a trip; a length of a trip; a vehicle style; a vehicle-to-vehicle communication; and/or a vehicle-to-infrastructure communication.

In one or more embodiments, the electronic risk measuring and scoring system 100 for the autonomous vehicle 101 is characterized in that the contextual risk data 3062 comprises real-time driving behaviors of the autonomous vehicle 101. Herein, the automated ranking unit 1102 is configured to generate the contextual risk data 3062 for measuring and/or generating a single or a compound set of variable scoring parameters profiling the use and/or style and/or environmental condition of driving during operation of the motor vehicle based upon the triggered, captured, and monitored sensory data of the sensors of the mobile telematics device 1021 and/or operating parameters or environmental parameters. These single or compound set of variable scoring parameters may include scoring parameters measuring a driving score and/or a contextual score and/or a vehicle safety score. For the driving score, the contextual score and the vehicle safety score, the variable driving scoring parameter is at least based upon a measure of driver behavior parameters comprising the identified maneuvers and/or speed and/or acceleration and/or braking and/or cornering and/or jerking, and/or a measure of distraction parameters comprising mobile phone usage while driving and/or a measure of fatigue parameters and/or drug use parameters; the variable contextual scoring parameter is at least based upon measured trip score parameters based on road type and/or number of intersection and/or tunnels and/or elevation, and/or measured time of travel parameters, and/or measured weather parameters and/or measured location parameters, and/or measured distance driven parameters; and the variable vehicle safety scoring parameter is at least based upon measured ADAS feature activation parameters and/or measured vehicle crash test rating parameters and/or measured level of automation parameters of the motor vehicle and/or measured software risk scores parameters. Measuring at least the trips and/or trip segments, the scoring measurement may be improved by further contributors, which may include contributors such as, distracted driving, speeding, drunk driving, reckless driving, rain, running red lights, running stop signs, teenage drivers, night driving, car design effects, and the like.

In one or more embodiments, the electronic risk measuring and scoring system 100 for the autonomous vehicle 101 is characterized in that the technical performance of autonomous vehicle 3063 comprises performance of the autonomous vehicle in terms of at least one of autonomous driving capability, automation level of the autonomous vehicle and navigation accuracy of the autonomous vehicle. Herein, the automated ranking unit 1102 is configured to estimate the technical performance of autonomous vehicle 3063 based on appropriate testing and simulations and providing score measures or indices used for tariffications and/or as input parameters for insurance/risk-transfer modelling. For testing and simulation purposes, the automated ranking unit 1102 may use the vehicle representative technologies and vehicle data (as available from the first database 104). In some examples, the quality of each autonomous operation feature and/or combination of features of the autonomous vehicle 101 is evaluated. This may be accomplished by testing the features and combinations in controlled environments, as well as analyzing the effectiveness of the features in the ordinary course of vehicle operation. New autonomous operation features may be evaluated based upon controlled testing and/or estimating ordinary-course performance based upon data regarding other similar features for which ordinary-course performance is known.

In one or more embodiments, the electronic risk measuring and scoring system 100 for the autonomous vehicle 101 is characterized in that the legal risk data 3064 comprises jurisdiction, vehicle liability and driver liability. Herein, the automated ranking unit 1102 is configured to estimate the legal risk data 3064 based on motor or product liability (re-)insurance systems and/or risk-transfer systems related to or depending on partially or fully automated vehicles. Especially the extent to which a vehicle is automated and/or the extent to which the automated features are activated (e.g., level of automation, e.g., according to predefined definitions and categorizations, as e.g., given by the levels 1 to 5 of the NHTSA (US National Highway Traffic Safety Administration)). Thus, the electronic risk measuring and scoring system capable of providing an automated risk-transfer structure for diverging coverages to risk-exposed autonomous or partially autonomous driving motor vehicles, as e.g., product liability for car and/or technology manufacturer, driver liability cover, which is not possible with the prior art systems.

In one or more embodiments, the electronic risk measuring and scoring system 100 for the autonomous vehicle 101 is characterized in that the cyber risk data 3065 comprises risk of forward-looking accidents due to autonomous vehicle hacking. Herein, the automated ranking unit 1102 is configured to estimate the cyber risk data 3065 by implementing probabilistic models to assess potential cyber losses. Bayesian Network (BN) probabilistic models are suited to cyber-risk assessment through their ability to append subjective expert adjudication to heterogeneous datasets that often contain missing, or conflicting, information. Compared with deterministic tools, these models look to quantify the full probability distribution of future losses instead of a single best estimate. In this sense they are closer to traditional actuarial approaches to modelling risk. Sometimes referred to as cyber value-at-risk (VaR), these models provide a foundation for quantifying risk and instill discipline and rigor into the risk assessment process.

Further, as shown in FIG. 1, the automotive risk-assessment computing unit 110 of the electronic risk measuring and scoring system 100 comprises a benchmarking unit 1103 for benchmarking autonomous vehicle risks and autonomous vehicle component risks associated with the autonomous vehicle 101 based on testing and/or simulating an autonomous vehicle modelling structure for the autonomous vehicle using technology data associated with the autonomous vehicle. As discussed in reference to the workflow 300 of FIG. 3, the system 100 provides partnerships with the autonomous vehicle providers (manufacturers) 312 to get access to vehicle representative technologies and vehicle data 314, which, in turn, provides the necessary autonomous vehicle modelling structure for the autonomous vehicle for testing and/or simulating the autonomous vehicle 101 (as represented by reference numeral 316 in the workflow 300 of FIG. 3). In an example, the testing and/or simulating the autonomous vehicle 101 involves input variables, such as, but not limited to, real driver experience of drivers (mass data); application cases defined for autonomous vehicles; and special application cases, which are possibly required by safety and reliability processes. Herein, the real driver experience is the collected experience of drivers of a multiplicity of vehicles of a fleet of vehicles over relatively long periods of time in the real world. The drivers are, for example, all those who drive a vehicle of a particular brand or a particular type. Mass data are collected, for example, CAN bus data, sensor data, vehicle communication data, etc. All these data are analyzed and classified in order to identify driving situations and to compile a collection of driving situations together with their frequency. Driving situations may be classified by different methods. For example, a catalogue may give a rough indication of what types of situations are relevant, for example being stationary, accelerations, emergency braking, starting the engine, etc. Alternatively, a classification algorithm may compile groups of driving situations in terms of different features, for example, vehicle speed, engine speed, pedal use, etc. Special application cases that are dedicated to safety processes, for example ISO 26262, or reliability processes, for example FMEA, may likewise be kept. On the basis of the driving situations identified in such a way, test cases are generated, which are referred to here as test cases from the real world. The various steps that lead to a particular driving situation, and the average reaction of the drivers may also be analyzed. This information then forms the basis for the generation of test case steps and benchmarking of the autonomous vehicle 101.

Further, as shown in FIG. 1, the automotive risk-assessment computing unit 110 of the electronic risk measuring and scoring system 100 comprises a risk class unit 1104 for generating a risk space with one or more risk classes for the autonomous vehicle based on the benchmarking. As used herein, risk classification is a method for grouping risks with similar characteristics to set insurance rates. As illustrated in FIG. 3, the workflow 300 may involve generating a global risk space (as represented by reference numeral 308) based on the ranking of the autonomous vehicle 101 as dependent on at least on one of the operational risk data 3061, the contextual risk data 3062, the technical performance of autonomous vehicle 3063, the legal risk data 3064 and the cyber risk data 3065 therefor. In an example, the global risk space 308 may comprise three categories, namely preferred risk, standard risk, and high risk, with all the autonomous vehicles being classified into one of the said three categories. Herein, the autonomous vehicles scoring high on benchmarks with low operational risk, contextual risk, technical performance risk, legal risk and cyber risk may be classified under preferred risk category; the autonomous vehicles scoring average on benchmarks with medium operational risk, contextual risk, technical performance risk, legal risk and cyber risk may be classified under standard risk category; and the autonomous vehicles scoring low on benchmarks with high operational risk, contextual risk, technical performance risk, legal risk and cyber risk may be classified under high risk category. As would be appreciated, the electronic risk measuring and scoring system 100 provides motor or product liability (re-)insurance systems and/or risk-transfer systems for the autonomous vehicle 101 based on the classified risk category therefor.

Further, as shown in FIG. 1, the automotive risk-assessment computing unit 110 of the electronic risk measuring and scoring system 100 comprises a scoring unit 1105 for generating scores or indices, to calibrate and rate and/or price risk-transfers, and/or as input for risk-transfer modeling, based on the one or more risk classes for the autonomous vehicle 101 and the ranking associated with the forward-looking accident frequencies and severities for the autonomous vehicle 101. As illustrated in the workflow 300 of FIG. 3, herein, the ranking is used two-fold. Firstly, the ranking is used to provide a global risk space, create appropriate risk classes, and streamline underwriting decisions (as represented by reference numeral 310). Secondly, the ranking is used for benchmarking the autonomous vehicle components and autonomous vehicle risks by means of appropriate testing and simulations and providing score measures or indices (as represented by reference numeral 318), which may further be used for tariffications and/or as input parameters for insurance/risk-transfer modelling (as represented by reference numeral 320). In general, the process may include evaluating a performance of the autonomous or semi-autonomous driving package of computer instructions in a test environment, analyzing loss experience associated with the computer instructions to determine effectiveness in actual driving situations, determining a relative accident risk factor for the computer instructions based upon the ability of the computer instructions to make automated or semi-automated driving decisions for a vehicle that avoid collisions, determining a vehicle insurance policy premium for the vehicle based upon the relative risk factor assigned to the autonomous or semi-autonomous driving package of computer instructions, and/or presenting information regarding the vehicle insurance policy to a customer for review, approval, and/or acceptance by the customer.

In the present system 100, a request is transmitted to the automotive risk-assessment computing unit 110 from the dynamic telematics circuit 102 via the data transmission network 103. The request comprises at least said single or a compound set of variable scoring parameters and/or risk-relevant parameters based upon the captured, triggered and monitored risk-related usage-based and/or user-based and/or operational telematics data. Herein, the request comprises at least risk-relevant parameters based upon the measured and/or generated single or compound set of variable scoring parameters. The risk-relevant parameters of the request may include at least usage-based and/or user-based and/or operating telematics data measured and/or generated by the mobile telematics devices 1021 based upon the triggered, captured, and monitored sensory data of the sensors of the mobile telematics device 1021 and/or operating parameters or environmental parameters, and the generated single or set compound of variable scoring parameters.

In an example, the requests may be periodically transmitted to the automotive risk-assessment computing unit 110 based on the dynamically generated single or compound set of variable scoring parameters and/or the triggered, captured, and monitored sensory data of the sensors of the mobile telematics device 1021 and/or operating parameters or environmental parameters. However, the requests may also be generated and transmitted to the plurality of automated first risk-transfer systems based on the dynamically generated single or compound set of variable scoring parameters and/or the triggered, captured, and monitored sensory data of the sensors of the mobile telematics device 1021 and/or operating parameters or environmental parameters, if the dynamic telematics circuit 102 triggers an alternation of the dynamically generated single or compound set of variable scoring parameters and/or the triggered, captured, and monitored sensory data of the sensors of the mobile telematics device 1021 and/or operating parameters or environmental parameters.

Further, in response to the transmitted request individualized risk-transfer profiles based upon the dynamically collected single or compound set of variable scoring parameters are transmitted from the automotive risk-assessment computing unit 110 to a corresponding vehicle 101 and issued by means of an interface of the mobile telematics devices 1021 for selection by the driver of the vehicles 101. That is, the dynamic telematics circuit 102 receives in response to the transmitted request a plurality of individualized risk-transfer profiles based upon the dynamically collected single or compound set of variable scoring parameters. Herein, the result list may be dynamically adapted in real-time and displayed to the user for selection via the dashboard or another interactive device of the mobile telematics devices 1021 and/or the vehicles 101. Further, the dynamic trip-detection telematics circuit 10 may dynamically capture and categorize the received plurality of individualized risk-transfer profiles of the automated first risk-transfer systems. The result list may be dynamically provided for display and selection to the user of the mobile telematics devices 1021 and/or vehicle 101 by means of the motor vehicles' dashboards based upon the triggered, captured, and monitored sensory data of the sensors of the mobile telematics device 1021 and/or operating parameters or environmental parameters during operation of the mobile telematics devices 1021 and/or vehicle 101.

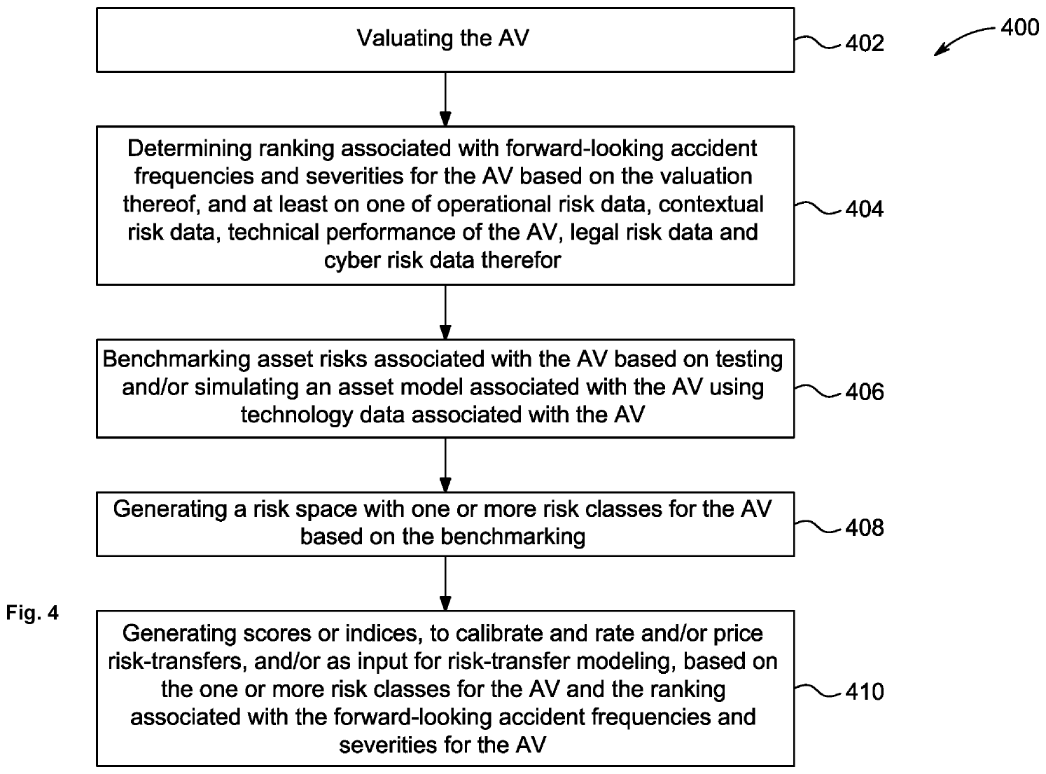

Referring now to FIG. 4, illustrated is a flowchart for electronic risk measuring and scoring method 400 for autonomous vehicles 101 provided with Advanced Driver-Assistance Systems (ADAS) features. The teachings of the disclosed electronic risk measuring and scoring system 100 may apply mutatis mutandis to the present electronic risk measuring and scoring method 400 without any limitations. At step 402, the present electronic risk measuring and scoring method 400 comprises valuating, by an autonomous vehicle component valuation unit (such as, the autonomous vehicle component valuation unit 1101, the autonomous vehicle (such as, the vehicle 101). At step 404, the electronic risk measuring and scoring method 400 further comprises determining, by an automated ranking unit (such as, the automated ranking unit 1102), ranking associated with forward-looking accident frequencies and severities for the autonomous vehicle 101 based on the valuation thereof, and at least on one of the operational risk data 3061, the contextual risk data 3062, the technical performance of autonomous vehicle 3063, the legal risk data 3064 and the cyber risk data 3065 therefor. At step 406, the electronic risk measuring and scoring method 400 further comprises benchmarking, by a benchmarking unit (such as, the benchmarking unit 1103), autonomous vehicle component risks and autonomous vehicle risks associated with the autonomous vehicle 101 based on testing and/or simulating an autonomous vehicle component modelling structure for the autonomous vehicle using technology data associated with the autonomous vehicle. At step 408, the electronic risk measuring and scoring method 400 further comprises generating, by a risk class unit (such as, the risk class unit 1104), a risk space with one or more risk classes for the autonomous vehicle based on the benchmarking. At step 410, the electronic risk measuring and scoring method 400 further comprises generating, by a scoring system (such as, the scoring unit 1105), scores or indices, to calibrate and rate and/or price risk-transfers, and/or as input for risk-transfer modeling, based on the one or more risk classes for the autonomous vehicle and the ranking associated with the forward-looking accident frequencies and severities for the autonomous vehicle.

The system and method of the present disclosure provide a dynamic, expert scoring system based on real-time scoring and measurements, and further provide a technically scalable solution based on scoring algorithms and data processing allowing to adapt and compare the signaling to other field of automated risk-transfer. The present disclosure achieves this, particularly, in that, by the risk score measure to evaluate the impact of ADAS features to the accident risk associated with the motor vehicles, and in that a risk-transfer is user-specific rated and calibrated capturing the impact of ADAS features in measures of risk-transfer claims frequency and severity. The present disclosure allows to measure the risk score measure as a risk-transfer typical rating factor, enabling to calibrated to users' specific portfolio, and to capture the impact of ADAS in terms of risk-transfer loss frequency and severity. The present disclosure is able to provides an automated risk-transfer system for all kinds of risk-transfer schemes, as, for example, motor or product liability (re-) insurance systems and/or risk-transfer systems related to or depending on partially or fully automated vehicles. Also, the present disclosure provides a holistic and unified, automated technical approach for coverage to the motor vehicles in all different structures of risk-transfer, as, for example, product liability for car and/or technology manufacturer, driver liability cover. Further, the present disclosure also provides a holistic technical solution that covers the whole range from automotive control circuits and/or telematics devices and/or app installations to the automated and accurate risk measuring, analysis, and management. Finally, the present disclosure is able to provide a dynamic real-time scoring and measurements, and further provides a technically scalable solution based on scoring algorithms and data processing allowing to adapt the signaling to other fields of automated risk-transfer.

The present disclosure may implement a processor for controlling overall operation of the electronic risk measuring and scoring system 100 and its associated components, including RAM, ROM, input/output module, and memory. Software may be stored within memory to provide instructions to the processor(s) for enabling the system to perform various functions. For example, memory may store software used by the system, such as an operating system, application programs, and associated databases. The processor and its associated components may allow the system 100 to run a series of computer-readable instructions to analyze risk parameters. In addition, the processor and its associated components may determine scores or indices, to calibrate and rate and/or price risk-transfers, and/or as input for risk-transfer modeling, for autonomous vehicles. In some implementations, the processor may operate in a networked environment supporting connections to one or more remote clients, such as terminals, PC clients and/or mobile clients of mobile devices. The processor can further comprise data stores for storing routing data, including routes that have been analyzed thereby in the past.

Appropriate network connections can e.g., include a local area network (LAN) and a wide area network (WAN) but may also include other networks. When used in a LAN networking environment, the automated dynamic routing unit 100 can be connected to the network through a network interface. When used in a WAN networking environment, the automated dynamic routing unit 100 includes means for establishing communications over the WAN, such as the Internet. The existence of any of various well-known protocols such as TCP/IP, Ethernet, FTP, HTTP, and the like is presumed. Additionally, an application program used by the automated dynamic routing unit 100 according to an embodiment of the disclosure may include computer executable instructions for invoking functionality related to determining a safe route and displaying the safe route for the user. In some implementations, the present automated dynamic routing unit 100 may be in the form of a mobile device, as e.g., smart phones, including various other components, such as a battery, speaker, camera, and antennas.

Obviously, numerous modifications and variations of the present disclosure are possible in light of the above teachings. It is therefore to be understood that within the scope of the appended claims, the invention may be practiced otherwise than as specifically described herein.

While various embodiment variants of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

### LIST OF REFERENCE SIGNS

100 Electronic accident frequency measuring and forecasting system
101 Vehicle, in particular autonomous vehicle (AV), ADAS or electric vehicle
   1011 Vehicle sensing system
      10111 Vehicle-based telematics sensors
      10112 Sensors and/or measuring devices
      10113 On-board diagnostic system
      10114 In-vehicle interactive device
   1012 Vehicle's data transmission bus
102 Dynamic telematics circuit
   1021 Mobile telematics devices
      10211 Further sensors
   1022 Vehicle-telematics driven aggregator
103 Data transmission network
104 First database
105 Second database
110 Automotive risk-assessment computing unit
   1101 Vehicle component valuation unit
   1102 Automated ranking unit
   1103 Benchmarking unit
   1104 Risk class unit
   1105 Scoring unit
202 Radar devices
204 LIDAR devices
206 Global positioning systems
208 Odometrical devices
210 Computer vision devices
212 Ultrasonic sensors
220 Proprioceptive sensors
300 Workflow
302 Vehicle accident risk assessment framework
304 Vehicle component valuation of the vehicle
306 Ranking of autonomous vehicle
   3061 Operational data
   3062 Contextual data
   3063 Technical performance of AV
   3064 Legal risk data
   3065 Cyber risk data
308 Global risk space
310 Creating risk classes and/or streamline underwriting decisions
312 Partnerships with AV providers
314 Vehicle data
316 Testing and/or simulating the AV
318 Score measures or indices
320 Tariffications and/or input parameters for insurance/risk-transfer modelling
400 Electronic and predictive accident risk measuring and scoring method
   402 Step 1
   404 Step 2
   406 Step 3
   408 Step 4
   410 Step 5

1. An electronic, automated vehicle risk measuring system for vehicles for testing new autonomous vehicle or Advanced Driver Assistance System (ADAS) or electric vehicle features, the system comprising:
a vehicle component valuation unit including:
a vehicle inventory generator for generating a digital vehicle component inventory for each of the vehicles,
a digital vehicle component inventory module holding data regarding a nature and a value amount for each vehicle component comprised in the digital vehicle component inventory, and
a vehicle component valuation engine simulating and/or modeling a time series of aggregated vehicle component values for each of the vehicles,
an automated ranking unit for determining a ranking associated with forward-looking accident frequencies and severities for one of the vehicles based on a component valuation, and at least operational risk data, contextual accident risk data, technical performance data of the one of the vehicles, legal risk data, and cyber risk data,
a benchmarking and measuring unit for measuring and benchmarking vehicle component impacts on accident probability measuring values associated with the one of the vehicles based on testing and/or simulating an autonomous vehicle component by means of an electronic modelling structure for the one of the vehicles using at least technology and vehicle architecture data associated with the one of the vehicles, each feature and/or combination of features being tested in controlled environments, effectiveness of the features being analyzed in an ordinary course of vehicle operation, and new features being evaluated based upon controlled testing based upon data regarding other similar features with known ordinary-course performance, and
an accident risk classification unit for dimensional measurement of an accident risk space with one or more risk classes for the vehicles based on the benchmarking,
wherein a current or future, quantitative accident frequency measure and/or accident risk score value is generated based on the accident risk space and the one or more risk classes assigned to the one of the vehicles.

2. The system according to claim 1, further comprising a scoring unit for generating score values or calibration indices, to calibrate and rate and/or price risk-covers, and/or as input for applicable risk-transfer modeling structures based on the one or more risk classes for one of the vehicles and the ranking associated with the forward-looking accident frequencies and severities for the one of the vehicles.

3. The system according to claim 1, wherein the vehicle component valuation unit performs a valuation of the one of the vehicles or vehicle components based on at least one of an age of the one of vehicles, a health of an engine of the one of the vehicles, a distance traveled by the one of the vehicles, a service history of the one of the vehicles, and an accident history of the one of the vehicles.

4. The system according to claim 1, wherein the operational risk data includes risk due to forward-looking accidents due to operations of the one of the vehicles.

5. The system according to claim 1, wherein the electronic modelling structure is based on a logistic regression model structure for determining and/or measuring and/or predicting statistically significant factors that affect crash severity for the vehicles.

6. The system according to claim 1, wherein the contextual risk data includes real-time driving behaviors of the one of the vehicles.

7. The system according to claim 1, wherein the technical performance data of the one of the vehicles includes performance of the one of the vehicles in terms of at least one of an autonomous driving capability, an automation level of the one of the vehicles, and a navigation accuracy of the one of the vehicles.

8. The system according to claim 1, wherein the legal risk data includes jurisdiction, vehicle liability, and driver liability.

9. The system according to claim 1, wherein the cyber risk data includes risk of forward-looking accidents due to autonomous vehicle hacking.

10. An electronic vehicle risk measuring method for vehicles for testing new autonomous vehicle or Advanced Driver Assistance System (ADAS) or electric vehicle features, the method comprising:
generating, by a vehicle inventory generator of a vehicle component valuation unit, a digital vehicle component inventory for each of the vehicles,
holding, by a digital vehicle component inventory module of the vehicle component valuation unit, data regarding a nature and a value amount for each vehicle component comprised in the digital vehicle component inventory,
simulating and modeling, by a vehicle component valuation engine of the vehicle component valuation unit, a time series of aggregated vehicle component values for each of the vehicles,
determining, by an automated ranking unit, a ranking associated with forward-looking accident frequencies and severities for one of the vehicles based on a component valuation, and at least on one of operational risk data, contextual accident risk data, technical performance data of the one of the vehicles, legal risk data, and cyber risk data,
measuring and benchmarking vehicle component impacts on accident probability measuring values associated with the one of the vehicles, by a benchmarking and measuring unit, based on testing and/or simulating an autonomous vehicle component by means of an electronic modelling structure for the one of the vehicles using at least technology and vehicle architecture data associated with the one of the vehicles, and
dimensionally measuring, by an accident risk classification unit, an accident risk space with one or more risk classes is dimension-depending for the vehicles based on the benchmarking,
wherein a current or future, quantitative accident frequency measure and/or accident risk score value is generated based on the accident risk space and/or the one or more risk classes assigned to the vehicle and/or the ranking associated with the forward-looking accident frequencies and the severities for the one of the vehicles.

11. The method according to claim 10, further comprising performing a valuation of the one of the vehicles, by the vehicle component valuation unit, based on at least one of an age of the one of the vehicles, a health of an engine of the one of the vehicles, a distance traveled by the one of the vehicles, a service history of the one of the vehicles, and an accident history of the one of the vehicles.

12. The method according to claim 10, wherein the operational risk data includes risk due to forward-looking accidents due to operations of the one of the vehicles.

13. The method according to claim 10, wherein the contextual risk data includes real-time driving behaviors of the one of the vehicles.

14. The method according to claim 10, wherein the technical performance data of the one of the vehicles includes performance of the one of the vehicles in terms of at least one of an autonomous driving capability, an automation level of the one of the vehicles and a navigation accuracy of the one of the vehicles.

15. The method according to claim 10, wherein the legal risk data includes jurisdiction, vehicle liability, and driver liability.

16. The method according to claim 10, wherein the cyber risk data includes risk of forward-looking accidents due to autonomous vehicle hacking.
